(19) United States
(12) Patent Application Publication
(10) Pub. No.: US 2026/0250815 A1
(43) Pub. Date: Aug. 27, 2026

(54) STEEL SHEET FOR HOT-STAMPING, METHOD FOR MANUFACTURING STEEL SHEET FOR HOT-STAMPING, AND HOT-STAMPED FORMED BODY

(71) Applicant: NIPPON STEEL CORPORATION, Tokyo (JP)

(72) Inventors: Masafumi AZUMA, Tokyo (JP); Akihiro SENGOKU, Tokyo (JP); Shota KIKUCHI, Tokyo (JP)

(73) Assignee: NIPPON STEEL CORPORATION, Tokyo (JP)

(21) Appl. No.: 18/726,057

(22) PCT Filed: Jan. 6, 2023
(86) PCT No.: PCT/JP2023/000115

§ 371 Date: Jul. 1, 2024

(30) Foreign Application Priority Data
Jan. 6, 2022 (JP) 2022-001017

(51) Int. Cl. C22C 38/14; B32B 15/01; C21D 1/74; C21D 6/00; C21D 8/04; C21D 9/48; C22C 18/00; C22C 38/00; C22C 38/02; C22C 38/04; C22C 38/06; C22C 38/08; C22C 38/10; C22C 38/12; C22C 38/16; C22C 38/20; C22C 38/26; C22C 38/28; C22C 38/32; C22C 38/60; C23C 2/02; C23C 2/06; C23C 2/28; C23C 2/40

(52) U.S. Cl. CPC C22C 38/14; B32B 15/013; C21D 1/74; C21D 6/001; C21D 6/002; C21D 6/005; C21D 6/007; C21D 6/008; C21D 8/0426; C21D 8/0436; C21D 8/0463; C21D 8/0478; C21D 9/48; C22C 18/00; C22C 38/001; C22C 38/002; C22C 38/005; C22C 38/008; C22C 38/02; C22C 38/04; C22C 38/06; C22C 38/08; C22C 38/10; C22C 38/12; C22C 38/16; C22C 38/20; C22C 38/26; C22C 38/28; C22C 38/32; C22C 38/60; C23C 2/0224; C23C 2/06; C23C 2/285; C23C 2/40; C21D 2211/002; C21D 2211/005; C21D 2211/008; C21D 2211/009

(57) ABSTRACT

This steel sheet for hot-stamping includes: a base steel sheet having a predetermined chemical composition; and a galvanized layer formed on a surface of the base steel sheet, in which a microstructure at a position at ¼ depth which is in a range of ⅛ to ⅜ of a sheet thickness in a sheet thickness direction from the surface of the base steel sheet contains, in volume fraction, ferrite: 20% to 95% and pearlite: 5% to 80%, the remaining structure including bainite, the galvanized layer has a coating amount of 35 g/m² or more, and a chemical composition of the galvanized layer includes 0.0005 mass % or more of B.

### TECHNICAL FIELD

The present invention relates to a steel sheet for hot-stamping, a manufacturing method thereof, and a hot-stamped formed body.

Priority is claimed on Japanese Patent Application No. 2022-001017, filed Jan. 6, 2022, the content of which is incorporated herein by reference.

### BACKGROUND ART

Weight reduction of components such as door guard bars and side members of automobiles has been examined weight reduction to respond to trends in reducing fuel consumption in recent years. In terms of materials, reduction of thickness is effective for weight reduction. However, if materials are simply made thinner, the load-bearing capacity of components decreases. Therefore, to secure strength and collision safety even with reduction of thickness, there has been a demand for high strength steel sheets used as materials for automobile parts.

However, formability of a material generally deteriorates as its strength increases. Therefore, to achieve the weight reduction of the above-described components, it is required for steel sheets used as materials thereof to have both excellent formability and high strength.

As a steel sheet having high strength and excellent formability at the same time, there is, for example, transformation induced plasticity (TRIP) steel which utilizes the martensitic transformation of residual austenite disclosed in Patent Documents 1 and 2, and applications of this TRIP steel have been expanding in recent years. However, TRIP steel has a problem that, although deep drawability and elongation during forming are improved, the shape fixability of a component after press forming is poor because the steel sheet strength is high.

In addition, Patent Documents 3 and 4 disclose ultra-high tensile strength steel sheets for cold pressing with a tensile strength of 1470 MPa or more. However, these steel sheets are subject to significant blade wear during shear cutting and trimming, although consideration is given to hydrogen embrittlement due to cold working. Alternatively, there is a problem that the pressing load is too high for cold pressing and it is difficult to perform cold rolling. Therefore, there is a major problem in making steel sheets for automobile parts even stronger.

For such problems, as shown in Patent Document 5, there exists a method called hot stamping in which, after cutting a soft steel sheet into a predetermined size, the steel sheet is heated to an austenitic single phase range of 800° C. or higher, press forming is carried out in an austenitic single phase range as disclosed in Patent Document 5, and then quenching is carried out. By applying this hot stamping, it is possible to manufacture components with a high strength of 980 MPa or more and excellent shape fixability while suppressing wear due to shearing and trimming and suppressing the press load.

However, in hot stamping, the steel sheet is heated to a high temperature exceeding 800° C. by being inserted into a heating furnace, or through electrical heating or far-infrared heating in atmospheric air. Therefore, there is a problem that even if plating is applied to the surface of a steel sheet for hot-stamping, a reaction between the plating and a base steel proceeds and the properties of the plating are lost. Therefore, there is a problem that plating steel sheets used for hot stamping (steel sheets for hot-stamping) could be utilized from the viewpoint of scale suppression, but might not contribute sufficiently to securing the rust resistance of formed bodies after hot stamping.

In response to these problems, in Patent Documents 6 and 7, hot-stamped formed bodies are disclosed in which zinc plating containing 9 mass % to 30 mass % of Fe is formed with an adhesion amount of 30 g/m² or more by suppressing volatilization of zinc by incorporating Si or Al into the plating layer.

The hot-stamped formed bodies of Patent Documents 6 and 7 can secure zinc plating in the formed bodies by suppressing the volatilization of zinc. However, even if zinc volatilization is suppressed, there is a problem that it is difficult to stably control the mass of Fe in the galvanized layer to be within the range of 9 mass % to 30 mass % because the alloying reaction between Fe and zinc proceeds during heating of hot stamping. In particular, when the heating temperature becomes high or the heating time becomes long, there is a problem that the alloying reaction between Fe and zinc proceeds excessively, and Fe in the galvanized layer becomes more than 30 mass %, resulting in loss of rust resistance. In addition, since the alloying reaction between Fe and Zn occurs unevenly from the interface between the plating layer and a base material, unevenness is formed on the surface of the plating layer along with the alloying reaction, and the film thickness of an electrodeposition coating, which is indispensable as a rust prevention treatment for automobile parts, becomes uneven. In other words, when the surface after the electrodeposition coating is flat, the electrodeposition film thickness of the convex portion of the plating layer becomes thin, and as a result, there is a problem such as a decrease in corrosion resistance due to peeling of the coating film. Therefore, it is necessary to solve the above-described problems.

### CITATION LIST

### Patent Documents

### [Patent Document 1]

Japanese Unexamined Patent Application, First Publication No. H1-230715

### [Patent Document 2]

Japanese Unexamined Patent Application, First Publication No. H2-217425

### [Patent Document 3]

Japanese Patent No. 6354921

### [Patent Document 4]

Japanese Patent No. 5365216

### [Patent Document 5]

Japanese Patent No. 3582512

### [Patent Document 6]

Japanese Patent No. 4671634

### [Patent Document 7]

Japanese Patent No. 4733522

### SUMMARY OF THE INVENTION

### Problems to be Solved by the Invention

As described above, there are problems in stable manufacturing of hot-stamped formed bodies having excellent rust resistance including corrosion resistance and adhesion of coating film in the conventional art.

In view of the above-described circumstances, an object of the present invention is to provide a hot-stamped formed body being little influenced by heating conditions during hot-stamping (it is possible to manufacture it under a wide range of heating conditions) and excellent rust resistance, a steel sheet for hot-stamping suitable as a material of the hot-stamped formed body, and a method for manufacturing a steel sheet for hot-stamping.

### Means for Solving the Problem

The present inventors have conducted extensive studies to solve the above-described problems. As a result, it has been found that the alloying reaction between Fe (iron) and Zn (zinc) is delayed by concentrating B in the galvanized layer of the steel sheet for hot-stamping, that hot-stamping formed body having a plating layer having a Γ phase containing 9 to 30 mass % of Fe could be obtained within a wide range of hot-stamping heat treatment conditions, and that in this hot-stamped formed body, corrosion resistance is high and peeling of a coating film during chemical conversion treatment and electrodeposition treatment could be suppressed.

The present invention has been made based on the above-described findings, and the gist thereof is as follows.
[1] A steel sheet for hot-stamping according to one aspect of the present invention includes: a base steel sheet; and a galvanized layer formed on a surface of the base steel sheet, in which the base steel sheet has, in mass %, a chemical composition including C: 0.030% to 0.600%, Si: 0.01% to 1.50%, Mn: 0.10% to 2.50%, Al: 0.001% to 0.100%, Ti: 0.010% to 0.100%, B: 0.0005% to 0.0100%, P: 0.100% or less, S: 0.0100% or less, N: 0.0150% or less, O: 0.0100% or less, Nb: 0% to 0.050%, V: 0% to 0.500%; W: 0% to 0.500%, Cr: 0% to 1.00%, Mo: 0% to 0.50%, Co: 0% to 1.000%, Ni: 0% to 1.00%, Cu: 0% to 1.00%, REM: 0% to 0.0100%, Zr: 0% to 0.0500%, Ca: 0% to 0.0100%, Mg: 0% to 0.0100%, As: 0% to 0.100%, Sn: 0% to 0.50%, Sb: 0% to 0.50%, and a remainder: Fe and impurities, a microstructure at a position at ¼ depth which is in a range of ⅛ to ⅜ of a sheet thickness in a sheet thickness direction from the surface of the base steel sheet contains, in volume fraction, ferrite: 20% to 95% and pearlite: 5% to 80%, the remaining structure including bainite, the galvanized layer has a coating amount of 35 g/m² or more, and a chemical composition of the galvanized layer includes 0.0005 mass % or more of B.
[2] In the steel sheet for hot-stamping according to [1], a chemical composition of the galvanized layer may include, in terms of mass, Fe: less than 9.0%.
[3] In the steel sheet for hot-stamping according to [1], a chemical composition of the galvanized layer may include, in terms of mass, Fe: 9.0% or more.
[4] In the steel sheet for hot-stamping according to any one of [1] to [3], the chemical composition of the base steel sheet may contain, in mass %, one or more selected from the group consisting of Nb: 0.005% to 0.050%, V: 0.005% to 0.500%, W: 0.005% to 0.500%, Cr: 0.01% to 1.00%, Mo: 0.01% to 0.50%, Co: 0.01% to 1.000%, Ni: 0.01% to 1.00%, Cu: 0.01% to 1.00%, REM: 0.0003% to 0.0100%, Zr: 0.0003% to 0.0500%, Ca: 0.0003% to 0.0100%, Mg: 0.0003% to 0.0100%, As: 0.001% to 0.100%, Sn: 0.01% to 0.50%, and Sb: 0.01% to 0.50%.
[5] A method for manufacturing a steel sheet for hot-stamping according to another aspect of the present invention, includes: casting a steel ingot or a slab having chemical components including, in mass %, C: 0.030% to 0.600%, Si: 0.01% to 1.50%, Mn: 0.10% to 2.50%, Al: 0.001% to 0.100%, Ti: 0.010% to 0.100%, B: 0.0005% to 0.0100%, P: 0.100% or less, S: 0.0100% or less, N: 0.0150% or less, O: 0.0100% or less, Nb: 0% to 0.050%, V: 0% to 0.500%, W: 0% to 0.500%, Cr: 0% to 1.00%, Mo: 0% to 0.50%, Co: 0% to 1.000%, Ni: 0% to 1.00%, Cu: 0% to 1.00%, REM: 0% to 0.0100%, Zr: 0% to 0.0500%, Ca: 0% to 0.0100%, Mg: 0% to 0.0100%, As: 0% to 0.100%, Sn: 0% to 0.50%, Sb: 0% to 0.50%, and a remainder: Fe and impurities; heating the steel ingot or the slab to 1,100° C. or higher and hot rolling the heated steel ingot or slab so that a finish rolling temperature is 800° C. or higher to obtain a hot-rolled steel sheet; coiling the hot-rolled steel sheet after the hot rolling in a temperature range of 600° C. or lower; pickling the hot-rolled steel sheet after the coiling, and then performing cold rolling at a cumulative rolling reduction of 30% to 80% to obtain a cold-rolled steel sheet; performing annealing by holding the cold-rolled steel sheet in an annealing furnace, in which an oxygen potential in an atmosphere is −1.20 to −0.50 and a temperature of the atmosphere is 650° C. or more and less than 800° C., for 30 seconds or longer and cooling the steel sheet so that the steel sheet surface temperature is 500° C. to 400° C.; performing plating by immersing the cold-rolled steel sheet after the annealing in a plating bath to form a plating layer with a coating amount of 35 g/m² or more; and cooling the cold-rolled steel sheet after the plating to 50° C. or lower.
[6] The method for manufacturing a steel sheet for hot-stamping according to [5], further includes: performing alloying by holding the cold rolled steel sheet in a furnace in which a temperature of the atmosphere is 460 to 600° C., for 5 seconds or longer may be performed between the plating and the cooling.
[7] A hot-stamped formed body includes: a base steel sheet; and a plating layer containing Zn and Fe and formed on a surface of the base steel sheet, in which the base steel sheet has, in mass %, a chemical composition including C: 0.030% to 0.600%, Si: 0.01% to 1.50%, Mn: 0.10% to 2.50%, Al: 0.001% to 0.100%, Ti: 0.010% to 0.100%, B: 0.0005% to 0.0100%, P: 0.100% or less, S: 0.0100% or less, N: 0.0150% or less, O: 0.0100% or less, Nb: 0% to 0.050%, V: 0% to 0.500%, W: 0% to 0.500%, Cr: 0% to 1.00%, Mo: 0% to 0.50%, Co: 0% to 1.000%, Ni: 0% to 1.00%, Cu: 0% to 1.00%, REM: 0% to 0.0100%, Zr: 0% to 0.0500%, Ca: 0% to 0.0100%, Mg: 0% to 0.0100%, As: 0% to 0.100%, Sn: 0% to 0.50%, Sb: 0% to 0.50%, and a remainder: Fe and impurities, a microstructure at a position at ¼ depth which is in a range of ⅛ to ⅜ of a sheet thickness in a sheet thickness direction from the surface of the base steel sheet contains, in volume fraction, martensite: 5% to 100% and ferrite: 0% to 95%, the remaining structure including one or two of bainite and pearlite, a Γ layer having a Fe content of 9 to 30 mass % in the plating layer has a coating amount of 30 g/m² or more, and when a maximum value of a B content in mass % in the plating layer is Be and a B content at a position at ¼ depth of the base steel sheet in mass % is Bq, Bc is 1.2 times or more Bq.
[8] In the hot-stamped formed body according to [7], the chemical composition of the base steel sheet may contain, in mass %, one or more selected from the group consisting of Nb: 0.005% to 0.050%, V: 0.005% to 0.500%, W: 0.005% to 0.500%, Cr: 0.01% to 1.00%, Mo: 0.01% to 0.50%, Co: 0.01% to 1.000%, Ni: 0.01% to 1.00%, Cu: 0.01% to 1.00%, REM: 0.0003% to 0.0100%, Zr: 0.0003% to 0.0500%, Ca: 0.0003% to 0.0100%, Mg: 0.0003% to 0.0100%, As: 0.001% to 0.100%, Sn: 0.01% to 0.50%, and Sb: 0.01% to 0.50%.

### Effects of the Invention

According to the above-described aspect of the present invention, it is possible to provide a hot-stamped formed body having excellent rust resistance (corrosion resistance and adhesion of coating film), a steel sheet for hot-stamping suitable as a material for the hot-stamped formed body, and a method for manufacturing the steel sheet for hot-stamping.

### EMBODIMENT OF THE INVENTION

Hereinafter, a steel sheet for hot-stamping according to one embodiment of the present invention (steel sheet for hot-stamping according to the present embodiment), a hot-stamped formed body according to one embodiment of the present invention (hot-stamped formed body according to the present embodiment), and manufacturing methods thereof will be sequentially described.

### [Steel Sheet for Hot-Stamping]

The steel sheet for hot-stamping according to the present embodiment includes a base steel sheet and a galvanized layer formed on the surface of the base steel sheet. The galvanized layer may be formed on a single surface or both surfaces of the base steel sheet.

### <Galvanized Layer>

### <<Coating Amount>>

The coating amount of the galvanized layer formed on the surface of the base steel sheet is 35 g/m² or more per one surface.

To secure the rust resistance of a hot-stamped formed body obtained through hot stamping of a steel sheet for hot-stamping, in a plating layer of the hot-stamped formed body, it is necessary for the coating amount of a Γ layer which is a layer including a Γ phase having 9 to 30 mass % of Fe among alloy layers of Zn and Fe to be 30 g/m² or more.

In the steel sheet for hot-stamping according to the present embodiment, as described below, B is contained in the galvanized layer to delay a reaction between Fe and zinc (Zn). Nevertheless, if the coating amount of the galvanized layer is less than 35 g/m², the alloying reaction between iron and zinc proceeds excessively during hot stamping heat treatment, and it may not be possible to secure a Γ layer sufficiently in the hot-stamped formed body. Therefore, the coating amount of the galvanized layer is set to 35 g/m² or more. The coating amount is preferably 40 g/m² or more. The upper limit of the coating amount is not limited, but the coating amount may be less than 90 g/m².

### <<Chemical Composition>>

A chemical composition of the galvanized layer contains 0.0005 mass % or more of B.

B is an element which delays the alloying reaction between Fe and Zn and contributes to securing the predetermined coating amount of the Γ layer and to suppress unevenness at the surface of the plating layer when B is contained in the galvanized layer. The unevenness at the surface of the plating layer of the hot-stamped formed body has correlation with adhesion of coating film after chemical conversion and electrodeposition coating. When the number of the unevenness is small, the adhesion of coating film which evaluated by warm salt water immersion test is improved. When the B content in the galvanized layer is less than 0.0005 mass %, sufficient effects cannot be obtained. Therefore, the B content in the galvanized layer is set to be 0.0005 mass % or more.

The upper limit of the B content is not limited. However, when the B content in the galvanized layer is more than 0.0100 mass %, annealing time becomes extremely long and is not economically preferable, even if hot rolling conditions and annealing conditions are set to the range of the present invention. Therefore, 0.0100 mass % is the substantial upper limit. B content may be 0.0060 mass % or less.

A remainder of the chemical composition other than B of the galvanized layer of the steel sheet for hot-stamping according to the present embodiment may be set to, in mass %, for example, Al: 0% to 1.00%, Fe: 0.1% to 20.0%, Si: 0% to 1.0%, Mg: 0 to 0.5%, Mn: 0 to 0.5%, Pb: 0 to 0.5%, Sb: 0 to 0.5%, and the remainder: Zn and impurities. The Zn content is preferably set to 80.0% or more and more preferably set to 85.0% or more.

In particular, Al contributes to securing a Γ layer in the hot-stamped formed body at 30 g/m² or more by forming an oxide on the surface layer during hot stamping heat treatment and preventing evaporation of Zn during hot stamping heat treatment. Therefore, Al does not have to be contained, but for the purpose of securing the stability of the Γ layer in the hot-stamped formed body, it is preferable to set the Al content to 0.01mass % or more. On the other hand, if the Al content exceeds 1.00 mass %, the formation of Al oxides becomes more significant during hot stamping, and the risk of generation of problems such as adverse effects on weldability and wear on press molds due to the formed oxides increases. Therefore, the Al content is preferably set to 1.00 mass % or less. The Al content is more preferably 0.40 mass % or less and even more preferably 0.35 mass % or less.

In the chemical composition of the galvanized layer, if the Fe content is less than 9.0 mass %, the Fe content in the galvanized layer of the steel sheet for hot-stamping is small, and even if the alloying reaction between Fe and Zn proceeds during hot stamping heat treatment, the time when the Fe content in the plating layer becomes 30 mass % or less is expanded. This is preferable in that it is easier to secure a large amount of Γ layer after hot stamping heat treatment.

On the other hand, if the Fe content is 9.0 mass % or more, since the hardness of the galvanized layer of the steel sheet for hot-stamping increases, it is possible to suppress appearance defects such as scratch which occurs during handling. In this case, the appearance of the hot-stamped formed body becomes good, which is preferable.

The chemical composition of the galvanized layer and the coating amount can be obtained through the following method.

The coating amount can be calculated and obtained from the weight change before and after dissolution by dissolving the entire galvanized layer by immersing it in a 5% HCl solution containing 0.02 mass % of an inhibitor (IBIT 700A, Asahi Chemical Co., Ltd.), which inhibits dissolution of Fe in steel sheets, for 10 minutes at room temperature. Whether or not the dissolution of the galvanized layer has been completed is determined based on the completion of foaming caused by hydrogen generation during dissolution. The chemical composition of the galvanized layer is measured by subjecting the solution which dissolved the above-described galvanized layer to ICP analysis. The chemical composition measured through this method is the average chemical composition of the galvanized layer.

<Base steel sheet>

### <<Microstructure>>

In the steel sheet for hot-stamping according to the present embodiment, a microstructure at a position at ¼ depth which is in a range of ⅛ to ⅜ of a sheet thickness in a sheet thickness direction from the surface of the base steel sheet contains, in volume fraction, ferrite: 20% to 95% and pearlite: 5% to 80%, the remaining structure including bainite.

The microstructure at a position at ¼ depth is defined because the microstructure at this position is a representative microstructure of a steel sheet and strongly correlates with the properties.

If the volume fraction of ferrite is less than 20%, the proportion of hard structures such as martensite and bainite becomes too high, and workability degrades. On the other hand, if the volume fraction of ferrite exceeds 95%, the volume fraction of pearlite, which becomes austenite during hot stamping heat treatment and becomes martensite during mold quenching, cannot be secured at 5% or more. In this case, the strength of a hot-stamped formed body obtained after hot stamping decreases, and sufficient strength cannot be obtained as the hot-stamped formed body. Therefore, the volume fraction of ferrite is set to be 20% to 95%.

Since pearlite contains a carbide, it contributes to high strength through hot stamping (heating and quenching). When the volume fraction of pearlite is less than 5%, the strength increase through hot stamping becomes insufficient and the strength of a hot-stamped formed body decreases. Therefore, the volume fraction of pearlite is set to be 5% or more. The volume fraction of pearlite is preferably 9% or more and more preferably 13% or more. On the other hand, when the pearlite volume fraction exceeds 80%, the ferrite volume fraction falls below 20%. Therefore, the volume fraction of pearlite is set to be 80% or less. Here, pearlite refers to a layered structure of ferrite and cementite. In the present embodiment, even if a portion of the cementite is divided or spheroidized, it is determined as pearlite.

The total volume fraction of ferrite and pearlite is preferably 95% or more.

The microstructure may contain 5% or less of bainite in volume fraction as a remainder other than ferrite and pearlite. Since bainite is a hard microstructure next to ferrite and pearlite, it may be incorporated as long as it does not increase the strength of the steel sheet for hot-stamping to a significant degree. The volume fraction of bainite exceeding 5% increases the strength of the steel sheet unnecessarily. The volume fraction of bainite is preferably 2% or less and may be 0%.

In the steel sheet for hot-stamping according to the present embodiment, a sample is collected using a cross section of the sheet thickness parallel to the rolling direction of the steel sheet as an observation surface, the observation surface is polished and subjected to nital etching, and the area of ⅛ to ⅜ of the sheet thickness from the surface centered at the ¼ position of the sheet thickness in the sheet thickness direction from the surface is observed using a field emission scanning electron microscope (FE-SEM) to measure the area proportion and take it as volume fraction.

At the time of measuring the area proportion, 10 fields of view are observed with a field size of 1,000 μm² or more at a magnification of 3000 times, and an average value thereof is regarded as an area proportion. Ferrite, pearlite, bainite, and martensite can also be determined by the following characteristics.

Ferrite is a bec phase which is an equiaxed grain without a carbide inside. Pearlite is a layered structure of a bec phase and cementite and can be distinguished through observation with an electron microscope. For bainite, there is upper bainite with cementite between laths of a bcc phase with a lath-like form and lower bainite with cementite having a single orientation relationship (having the same variant) within the laths, and either microstructure can be distinguished through electron microscope observation. Since both the upper bainite and the lower bainite are hard and bring about high strength of the steel sheet for hot-stamping, they are both bainite in the present embodiment. For martensite, there is fresh martensite consisting of a bet phase or bcc phase having a lath-like form and containing no carbide and tempered martensite containing cementite (iron-based carbides) with multiple orientation relationships (lower bainite also contains cementite within laths, but differs in that it has only one orientation relationship), and either can be distinguished through electron microscope observation. The volume fraction of martensite does not need to be measured here, but can also be measured through this method.

### <<Chemical Composition>>

The chemical composition of the base steel sheet of the steel sheet for hot-stamping according to the present embodiment will be described. Hereinafter, % for the content of each element means mass %.

### C: 0.030% to 0.600%

C is an effective element to increase the strength of steel. When the C content is less than 0.030%, the maximum tensile strength (tensile strength) of a hot-stamped formed body cannot be sufficiently secured. For this reason, the C content is set to 0.030% or more. The C content is preferably 0.050% or more and more preferably 0.080% or more.

On the other hand, if the C content exceeds 0.600%, the weldability or workability becomes insufficient. For this reason, the C content is set to 0.600% or less. The C content is preferably 0.550% or less and more preferably 0.500% or less.

### Si: 0.01% to 1.50%

Si is a solid-solution strengthening element. Since an increase in strength becomes significant when the Si content is 0.01% or more, the Si content is set to 0.01% or more.

On the other hand, when the Si content exceeds 1.50%, not only the effect is saturated but also the Ac3 point is raised and it is not preferable because it is necessary to increase the heating temperature during hot stamping forming. For this reason, the Si content is set to 1.50% or less.

### Mn: 0.10% to 2.50%

Mn is an element that enhances hardenability. By setting the Mn content to 0.10% or more, the ferrite transformation in a cooling process during hot stamping is delayed, and the martensite volume fraction of the hot-stamped formed body can be set to 5% or more. For this reason, the Mn content is set to 0.10% or more.

On the other hand, there is a concern that if the Mn content exceeds 2.50%, the hardenability becomes too high and the strength of the hot-rolled steel sheet becomes too high, causing the sheet to fracture when cold-rolled. For this reason, the Mn content is set to 2.50% or less.

### Al: 0.001% to 0.100%

Al is an element that acts as a deoxidizing material. If the Al content is less than 0.001%, a sufficient deoxidation effect cannot be obtained, and a large amount of inclusions (oxides) is present in the steel sheet. These inclusions are not preferable because they are the origin of destruction during hot stamping and cause fracture. For this reason, the Al content is set to 0.001% or more. The Al content is preferably 0.005% or more.

On the other hand, if the Al content exceeds 0.100%, the Ac3 point is raised, it is necessary to increase the heating temperature during hot stamping, and productivity is reduced. For this reason, the Al content is set to 0.100% or less.

### Ti: 0.010% to 0.100%

Ti is an element that contributes to the increase in the strength and toughness of the hot-stamped formed body through fine grain strengthening by suppressing grain growth of austenite in a heating process during hot stamping. In addition, Ti is an element that inhibits B from forming a nitride by binding to N and forming TIN. To obtain this effect, the Ti content is set to 0.010% or more. The Ti content is preferably 0.012% or more and more preferably 0.015% or more.

On the other hand, there is a concern that if the Ti content exceeds 0.100%, Ti carbide is formed, the amount of C that contributes to strengthening martensite is reduced, and the strength of the hot-stamped formed body decreases. For this reason, the Ti content is set to 0.100% or less. The Ti content is preferably 0.080% or less and more preferably 0.060% or less.

### B: 0.0005% to 0.0100%

B is an effective element to diffuse into a plating layer during hot stamping, to delay a reaction between Fe and Zn during hot stamping, and to improve corrosion resistance and adhesion of coating film. To obtain these effects, the B content is set to 0.0005% or more. The B content is preferably 0.0007% or more and more preferably 0.0009% or more. In the steel sheet for hot-stamping according to the present embodiment, even if B is added to a plating bath, B cannot be stably contained in the plating layer because oxidation or the like occurs. For this reason, B is contained in the plating layer such that B is contained in the base steel sheet and is concentrated on the surface of the steel sheet through an annealing process and then plated as described below.

On the other hand, if the B content exceeds 0.0100%, not only the effect is saturated, but also iron-based borides precipitate and the hardenability improvement effect of B is not obtained. For this reason, the B content is set to 0.0100% or less. The B content is preferably 0.0080% or less, more preferably 0.0060% or less, and still more preferably 0.0030% or less.

### P: 0.100% or Less

P is an element that is segregated near the center portion of the sheet thickness of the steel sheet and also an element that makes a welded part embrittle. Therefore, it is preferable to have a smaller P content. If the P content exceeds 0.100%, embrittlement of a welded part becomes noticeable, and therefore the P content is set to 0.100% or less. The P content is preferably 0.080% or less and more preferably 0.050% or less. The lower limit of the P content need not be particularly specified (it may be 0%), but since reducing the P content to less than 0.001% is economically disadvantageous, the P content may be set to 0.001% or more.

### S: 0.0100% or Less

S is an element that adversely affects weldability and manufacturability during casting and hot rolling, Therefore, it is preferable to have a smaller S content. If the S content exceeds 0.0100%, the above-described adverse effect becomes noticeable, and therefore the S content is set to 0.0100% or less. The lower limit of the S content need not be particularly specified (it may be 0%), but since reducing the S content to less than 0.0001% is economically disadvantageous, the S content may be set to 0.0001% or more.

### N: 0.0150% or Less

N is an element that forms coarse nitrides and degrades bendability and hole expandability. N is also an element that causes blowholes during welding. It is preferable to have a smaller N content. If the N content exceeds 0.0150%, the bendability and the hole expandability deteriorate significantly. For this reason, the N content is set to 0.0150% or less. The lower limit of the N content need not be particularly specified (it may be 0%), but if the N content is reduced to less than 0.0001%, manufacturing costs increases significantly, and therefore the N content may be 0.0001% or more or 0.0005% or more.

### O: 0.0100% or Less

O is an element that forms an oxide and is present as an inclusion in steel. This inclusion leads to property degradation of steel sheets for hot-stamping. It is preferable to have a smaller O content (it may be 0%). If the O content exceeds 0.0100%, the above-described trend becomes significant. For this reason, the O content is set to 0.0100% or less. The O content is preferably 0.0050% or less.

On the other hand, reducing the O content to less than 0.0001% leads to excessive cost increases and is not economically preferable. Therefore, the O content may be set to 0.0001% or more.

The oxide described herein is an oxide present as an inclusion in a steel sheet and is different from a scale formed during hot stamping. In addition, since the steel sheet for hot-stamping according to the present embodiment has a galvanized layer, it is possible to suppress formation of iron oxides on the surface of the base steel sheet.

In the chemical composition of the base steel sheet of the steel sheet for hot-stamping according to the present embodiment, the remainder other than the above-described elements may be Fe and impurities. On the other hand, if necessary, the following elements (optional elements) may be further contained. Since optional elements may not be necessarily contained, the lower limit of all of them is 0%. In addition, even if the amount thereof is below the range in which a clear effect is obtained. it does not adversely affect the properties of the steel sheet for hot-stamping according to the present embodiment.
Nb: 0% to 0.050%
V: 0% to 0.500%
W: 0% to 0.500%

Nb, V and W are elements that contribute to the increase in the strength and toughness through fine grain strengthening by suppressing grain growth of austenite in a heating process during hot stamping. Therefore, these may be contained. To obtain this effect, the amount of each of Nb, V and/or W is preferably 0.005% or more. More preferably, the Nb content, the V content, and the W content are each 0.010% or more.

On the other hand, if the Nb content exceeds 0.050%, or the V content or the N content exceeds 0.500%, carbides of these elements are formed and the amount of C contributing to strengthening of martensite is reduced, which causes the strength of the hot-stamped formed body to decrease. Therefore, the Nb content is set to 0.050% or less, and the V content and the W content are each set to 0.500% or less.
Cr: 0% to 1.00%
Mo: 0% to 0.50%
Co: 0% to 1.000%
Ni: 0% to 1.00%
Cu: 0% to 1.00%

Cr, Mo, Co, Ni, and Cu are all elements that enhance hardenability during hot stamping, promote the formation of martensite, and contribute to high strength of hot-stamped formed bodies. This effect is significantly achieved by incorporating 0.001% or more of Co and/or one or more of 0.01% or more of each of Cr, Mo, Ni, Cu.

Therefore, it is preferable to set the Co content to 0.001% or more, and each of the Cr content, the Mo content, the Ni content, and the Cu content to 0.01% or more. On the other hand, if the amount of these elements becomes excessive, weldability, hot workability, and the like deteriorate, or the strength of the steel sheet for hot-stamping becomes too high, causing manufacturing troubles. Therefore, each of the Cr content, the Cu content, and the Ni content is set to 1.00% or less, the Co content is set to 1.000% or less, and the Mo content is set to 0.50% or less.
REM: 0% to 0.0100%
Zr: 0% to 0.0500%
Ca: 0% to 0.0100%
Mg: 0% to 0.0100%

For the purpose of improving the toughness of the hot-stamped formed body, one or more of REM, Zr, Ca, and Mg may be further contained. To obtain a sufficient effect, it is preferable to contain one or more of REM, Zr, Ca, and Mg at 0.0003% or more. Because these elements have a strong binding force to oxygen or S, these transform coarse oxides or sulfides formed in the steel sheet into fine oxides, thereby contributing to improving the toughness of hot-stamped formed body and suppressing fracture during collision deformation.

On the other hand, if the REM content, the Ca content, and the Mg content each exceed 0.0100%, or if the Zr content exceeds 0.0500%, the castability and the hot workability deteriorates. Therefore, the REM content, the Ca content, and the Mg content are each set to 0.0100% or less, and the Zr content is set to 0.0500% or less.

In the present embodiment, REM stand for rare earth metals and refer to Y and elements belonging to the lanthanoid series including La and Ce. The REM is often incorporated as mischmetal, and in addition to La and Ce, it may also contain complex elements of the lanthanide series,
As: 0% to 0.100%
Sn: 0% to 0.50%
Sb: 0% to 0.50%

For the purpose of further improving the rust resistance, one or more of As, Sn, and Sb may be further contained. To obtain this effect, it is preferable to set the As content to 0.020% or more and/or each of the Sn content and the Sb content to 0.02% or more.

On the other hand, if the As content exceeds 0.100%, the Sn content exceeds 0.50%, or if the Sb content exceeds 0.50%, the castability and the hot workability deteriorates. Therefore, the As content is set to 0.100% or less, and the Sn content and the Sb content are each set to 0.50% or less.

The above-described chemical composition may be measured by a general analysis method. For example, the chemical composition may be measured through Inductively Coupled Plasma-Atomic Emission Spectrometry (ICP-AES). C and S may be measured through a combustion-infrared absorption method, and N may be measured through an inert gas fusion-thermal conductivity method. In the steel sheet for hot-stamping according to the present embodiment, the chemical composition (element concentration) of the surface layer portion of the base steel sheet is different from that at a position at ¼ depth or at an average value throughout the thickness because B in the surface layer portion of the steel sheet is concentrated in the plating layer or at an interface with the plating layer through atmosphere control during annealing. Therefore, after removing a 150 μm area from the surface of the base steel sheet through polishing, component analysis is carried out. If the above-described region is to be removed, it may be removed either at a position at ¼ depth or at an average throughout the thickness.

In the steel sheet for hot-stamping according to the present embodiment, B in the surface layer portion of the base steel sheet is concentrated on the surface and B concentrated on the surface is diffused in the plating layer as described below. Therefore, in the surface layer portion of the steel sheet for hot-stamping, there may be an area in which the B content (concentration) has decreased.

Specifically, the B content at a position of 10 μm in the depth direction (sheet thickness direction) from the surface of the base steel sheet may be 0.80 times (80%) or less of the B content at a position at ¼ depth of the sheet thickness of the base steel sheet.

In this case, in addition to the fact that B is sufficiently diffused in the plating layer, by suppressing an alloying reaction between a galvanized layer and the base steel sheet during hot stamping heat treatment, it is possible to make the coating amount of a l′ layer having a Fe content of 9 to 30 mass % to 30 g/m² or more, which is preferable because a hot-stamped formed body having excellent rust resistance can be obtained.

On the other hand, adding B to a plating bath is also considered as a method of incorporating B into the plating bath. However, as a result of examination by the present inventors, B becomes a compound such as an oxide due to a high temperature of the plating bath, and the alloying reaction between the galvanized layer and the base steel sheet during hot stamping heat treatment cannot not be suppressed because the oxide cannot be concentrated as B in the plating layer.

The B content in mass % at a depth of 10 μm from the surface of the base steel sheet can be measured by cutting out a 50 mm wide×50 mm long test piece from the steel sheet for hot-stamping and measuring the B content in mass % through GDS.

### <Strength of Steel Sheet for Hot-Stamping>

The steel sheet for hot-stamping according to the present embodiment can secure excellent rust resistance after hot stamping regardless of its strength. However, although high strength is required to be ensured for a formed body after hot stamping, it is required for the steel sheet for hot-stamping to be easily cut or press-formed. For this reason, it is not preferable to increase the strength of the steel sheet for hot-stamping used for cutting and press forming. Therefore, the tensile strength of the steel sheet for hot-stamping is desirably 980 MPa or less.

### [Method for Manufacturing Steel Sheet for Hot-Stamping]

Next, the method for manufacturing a steel sheet for hot-stamping according to the present embodiment is described. Well-known conditions can be applied for conditions not described below.

The steel sheet for hot-stamping according to the present embodiment can be manufactured through a manufacturing method including the following processes.
(I) A casting process for casting a steel ingot or slab having a predetermined chemical composition.
(II) A hot rolling process for heating the steel ingot or the slab to 1,100° C. or higher and hot rolling the heated steel ingot or slab so that a finish rolling temperature is 800° C. or higher to obtain a hot-rolled steel sheet.
(III) A coiling process for coiling the hot-rolled steel sheet after the hot rolling process in a temperature range of 600° C. or lower.
(IV) A cold rolling process for pickling the hot-rolled steel sheet after the coiling process, and then performing cold rolling at a cumulative rolling reduction of 30% to 80% to obtain a cold-rolled steel sheet.
(V) An annealing process for holding the cold-rolled steel sheet in an annealing furnace, in which an oxygen potential in an atmosphere is −1.20 to −0.50 and a temperature of the atmosphere is 650° C. o more and less than 800° C., for 30 seconds or longer and cooling the steel sheet so that the steel sheet surface temperature becomes 500° C. to 400° C. after holding.
(VI) A plating process for immersing the cold-rolled steel sheet after the annealing process in a plating bath to form a galvanized layer with a coating amount of 35 g/m² or more per single surface.
(VII) A cooling process for cooling the cold-rolled steel sheet after the plating process to 50° C. or lower.

Preferred conditions for each process is described.

### <Casting Process>

In the casting process, a steel ingot or slab with the same chemical composition as the steel sheet for hot-stamping according to the present embodiment is cast. Continuous casting slabs or ones manufactured by thin slab casters and the like can be used as slabs. This manufacturing method is also compatible with processes such as continuous casting-direct rolling (CC-DR), in which hot rolling is performed immediately after casting.

### <Hot Rolling Process>

In the hot rolling process, the cast steel ingot or slab is heated to 1,100° C. or higher and the heated steel ingot or slab is hot rolled so that a finish rolling temperature is 800° C. or higher to obtain a hot-rolled steel sheet.

Heating temperatures below 1,100° C. result in lower finish rolling temperatures. In this case, rolling becomes difficult or causes shape defects in the steel sheet after rolling. Therefore, the heating temperature is set to 1,100° C. or higher. However, if the temperature of the steel ingot or slab after casting is 1,100° C. or higher, hot rolling may be performed without heating.

In addition, if the finish rolling temperature is below 800° C., the rolling load becomes high, making rolling difficult and causing shape defects in the steel sheet after rolling. Therefore, the finish rolling temperature is set to 800° C. or higher. The upper limit of the finish rolling temperature is not necessarily specified, but an excessively high finish rolling temperature requires an excessively high heating temperature to secure that temperature, and therefore, the finish rolling temperature is preferably 1,100° C. or lower.

### <Coiling Process>

In the hot rolling process, the hot-rolled steel sheet after the hot rolling process is coiled in a temperature range of 600° C. or lower. If the coiling temperature exceeds 600° C., the thickness of oxides formed on the steel sheet surface increases excessively and pickling performance deteriorates, which is not preferable. In addition, B concentrates in the iron oxides formed during coiling, and the B content (concentration) in the surface layer portion of the steel sheet decreases, which is not preferable because the B concentration in the surface layer portion of the steel sheet in the subsequent process is not sufficient.

On the other hand, if the coiling temperature is lower than 400° C., the strength of the hot-rolled steel sheet is significantly increased, which easily induces sheet fracture and shape defects during cold rolling. Therefore, when performing cold rolling thereafter, the coiling temperature is desirably set to 400° C. or higher. However, if the coiled hot-rolled steel sheet is softened through heating in a box annealing furnace or a continuous annealing facility, coiling may be performed at low temperatures lower than 400° C.

Rough-rolled sheets may be joined to each other during hot rolling and jointed sheets may be subjected to finish rolling continuously. In addition, the rough-rolled sheet may also be coiled once.

### <Cold Rolling Process>

In the cold rolling process, the hot-rolled steel sheet after the coiling process is pickled, and then cold-rolled at a rolling reduction (cumulative rolling reduction) of 30% to 80% to obtain a cold-rolled steel sheet. The purpose of pickling is to remove scales formed during hot rolling. Pickling is preferably performed using hydrochloric acid with an inhibitor, but may be performed using other acids such as hydrochloric acid without an inhibitor, sulfuric acid, nitric acid, or a composite of these acids as long as the scales on the surface can be removed through pickling.

If the rolling reduction is smaller than 30%, it becomes difficult to keep the shape of the steel sheet flat and the ductility of a final product deteriorates. Therefore, the rolling reduction is set to 30% or larger.

On the other hand, if the rolling reduction exceeds 80%, the rolling load becomes too large and cold rolling becomes difficult. Therefore, the rolling reduction is set to 80% or smaller. The rolling reduction is preferably 40% to 70%. Itis unnecessary to particularly specify the number of rolling passes and the rolling reduction per pass.

### <Annealing Process>

In the annealing process, the cold-rolled steel sheet is annealed by being held in an annealing furnace, in which an oxygen potential in an atmosphere is −1.20 to −0.50 and a temperature of the atmosphere is 650° C. or more and less than 800° C., for 30 seconds or longer, and cooled so that the steel sheet surface temperature becomes 500° C. to 400° C. after holding.

The annealing process is preferably performed by passing the sheet through a continuous hot-dip galvanizing line to continuously perform with a subsequent plating process.

During annealing, the annealing temperature (atmospheric temperature) is set to 650° C. or more and less than 800° C. to soften the steel sheet and to concentrate B on the steel sheet surface. If the annealing temperature is in the range of 650° C. or more and less than 800° C., dislocations introduced during cold rolling are released by recovery, recrystallization, or phase transformation, and therefore, annealing is desirably performed in this temperature range. When the annealing temperature (atmospheric temperature) exceeds 750° C., austenite is formed during annealing and tends to transform to bainite or martensite during subsequent cooling, resulting in hardening. In addition, since austenite diffuses B more slowly than ferrite, it takes a longer time for B to concentrate in the surface layer, and B concentration in the galvanized layer tends to decrease in the subsequent plating process. Therefore, the annealing temperature (atmospheric temperature) is preferably set to 750° C. or lower. However, if the annealing temperature (atmospheric temperature) is higher than 750° C. and less than 800° C., the steel sheet for hot-stamping tends to be harder and it is necessary for the heat treatment time (annealing time) to be longer to secure rust resistance compared to when the annealing temperature (atmospheric temperature) is set to 650° C. to 750° C., but both cases are limited. Therefore, even when the annealing temperature (atmospheric temperature) is set to be higher than 750° C. and less than 800° C., the steel sheet for hot-stamping according to the present embodiment can be obtained.

On the other hand, if the annealing temperature is lower than 650° C., it becomes difficult to recrystallize the cold-rolled steel sheet and softening, which is the purpose of annealing, cannot be achieved. Therefore, the annealing temperature is set to 650° C. or higher.

The oxygen potential in an atmosphere during annealing is set to −0.50 to −1.20. If the oxygen potential exceeds-0.50, not only does the effect of B concentration in the surface layer become saturated, but also the oxygen potential in the furnace becomes too high, resulting in degradation of hearth rolls or refractories in the furnace. If the oxygen potential is less than-1.20, B cannot be concentrated on the steel sheet surface during annealing, and as a result, B cannot be sufficiently contained in the galvanized layer.

The oxygen potential in the furnace is defined as log (PH₂O/PH₂), where PH₂O is water vapor partial pressure in an atmosphere and PH₂ is hydrogen partial pressure in an atmosphere.

In the case of the above-described oxygen potential, for example, the dew point is 0° C. to +20° C. in an atmosphere containing about 10% hydrogen.

If the holding time at 650° C. or more and less than 800° C. is less than 30 seconds, B concentration on the steel sheet surface is insufficient and it is difficult to obtain the predetermined coating amount of the Γ layer. On the other hand, if the retention time exceeds 6,000 seconds, not only does the effect become saturated, but also the economic rationality becomes poor, which is not preferable.

B is concentrated on the surface of the steel sheet through this annealing process. The reason for concentrating B in the annealing process is that even if B is concentration on the surface of the steel sheet during the hot rolling process, for example, the B-concentrated layer is removed by pickling or the like before subsequent cold rolling, and B cannot be diffused into the plating layer in the plating process. In addition, this is because if B is concentrated in the iron oxides formed during coiling, the B concentration in the surface layer of the steel sheet decreases, and therefore the B concentration in the surface layer of the steel sheet in the subsequent process is not sufficient.

After holding, the steel sheet is cooled to a surface temperature of 500° C. to 400° C. for the subsequent plating process.

In general, the temperature of the plating bath is about 450° C. Therefore, immersing the steel sheet in the plating bath at lower than 400° C. causes problems such as plating is solidified, resulting in non-plating. On the other hand, when the steel sheet is immersed in the plating bath at temperatures exceeding 500° C., zinc oxides are formed during plating, resulting in non-plating. For this reason, the steel sheet to be used in the plating process is cooled to 500° C. to 400° C. During cooling, the average cooling rate is preferably lower than 2.0° C./second because reducing the temperature difference within the sheet makes the immersion temperature in the plating bath constant, which contributes to the suppression of non-plating and uneven alloying.

### <Plating Process>

In the plating process, the cold-rolled steel sheet after the annealing process is immersed in a plating bath to form a galvanized layer with a coating amount of 35 g/m² or more. The plating bath may be adjusted according to the chemical composition of the plating layer to be obtained, and the temperature of the plating bath may be within a well-known range. The coating amount of the galvanized layer can be adjusted through wiping after pulling it out of the plating bath.

### <Alloying Process>

The cold-rolled steel sheet in which the galvanized layer is formed may be heated to 460 to 600° C. to perform alloying, as necessary. By perform alloying, it is possible that Fe content in the galvanized layer is set to 9.0 mass % or more. When performing the alloying, alloying in less than 460° C. needs to long time for alloying and productivity deteriorates. On the other hand, when alloying in more than 600° C. is performed, not only effects are saturated, but also is not economically preferable.

In the steel sheet for hot-stamping according to the present embodiment, since it is desirable to reduce the Fe content in the plating layer to form a Γ layer after hot stamping heat treatment, the alloying heat treatment is not performed or the cold-rolled steel sheet with the galvanized layer is heated to 460° C. to 490° C. for limited alloying. Here, limited alloying means that alloying heat treatment is performed so that the Fe content is less than 9.0% in the chemical composition of the galvanized layer. Heat treatment at temperatures exceeding 490° C. is not preferable because the Fe content in the steel sheet for hot-stamping becomes 9.0% or higher. Alloying heat treatment at lower than 460° C. requires a longer time for alloying, resulting in lower thermal and time efficiency. However, for the purpose of manufacturing a hot-dip galvanized steel sheet, heat treatment may be performed in a temperature range where an alloying reaction does not proceed.

### <Cooling Process>

The cold-rolled steel sheet after the plating process or the alloying process is cooled to 50° C. or lower, for example, to room temperature. The cooling conditions are not limited.

### [Hot-Stamped Formed Body]

Next, the hot-stamped formed body according to the present embodiment will be described.

The hot-stamped formed body according to the present embodiment includes a base steel sheet and a plating layer which contains Zn and Fe and is formed on the surface of the base steel sheet.

The base steel sheet referred to herein does not necessarily have to be flat, but includes those formed into various shapes through press working or the like.

The hot-stamped formed body according to the present embodiment is obtained through hot-stamping the steel sheet for hot-stamping according to the present embodiment as described below.

### <Plating Layer>

The plating layer of the hot-stamped formed body according to the present embodiment is a plating layer which contains Zn and Fe and is formed by alloying Zn of the galvanized layer on the surface of the steel sheet for hot-stamping with Fe of the steel sheet through hot stamping.

In the plating layer containing Zn and Fe, multiple layers may be formed depending on the ratio of Zn to Fe. The plating layer of the hot-stamped formed body according to the present embodiment has a coating amount of 30 g/m² or more of a Γ layer including a Γ phase having 9 to 30 mass % of a Fe content.

This Γ layer, for example, has, in mass %, a chemical composition including Al: 0% to 1.00%, Fe: 9.0 to 30.0%, Si: 0% to 1.0%, Mg: 0% to 0.5%, Mn: 0% to 0.5%, Pb: 0% to 0.5%, Sb: 0% to 0.5%, Ni: 0 to 5.0%, Co: 0% to 5.0%, Mn: 0% to 5.0%, P: 0% to 0.5%, B 0.0005% to 0.1000%, and the remainder of Zn and impurities.

In addition, the plating layer of the hot-stamped formed body according to the present embodiment may have one or more oxides of Al, Si, Mn, and Zn in the topmost layer, a Γ layer on base steel sheet side next to the oxides, and a zinc solid solution of Fe on base steel sheet side next to the Γ layer.

If the coating amount of the Γ layer having a Fe content of 9 to 30 mass % is less than 30 g/m², sufficient rust resistance cannot be secured. The coating amount of the Γ layer is preferably 35 g/m² or more. The upper limit of the coating amount is not limited, but the coating amount of the Γ layer may be less than 45 g/m².

In plating layers containing Zn and Fe, sacrificial corrosion protection properties are lost if the Fe content in any layer exceeds 30 mass %. On the other hand, if the Fe content is less than 9%, the Fe content in the plating layer is too low and the plating is soft and likely to be scratched, which is not preferable.

As a layer other than the Γ layer, a solid solution layer mainly composed of Fe may also be formed at 5 g/m² or more, but no particular restriction is placed on the presence of this layer.

Even if the surface oxide film is removed with an alkaline or acid solution after quenching treatment through hot stamping to improve adhesion of coating film and chemical conversion treatability, the hot-stamped formed body is within the range of the hot-stamped formed body according to the present embodiment as long as the Zn—Fe alloy layer (Γ layer) which is mainly composed of Zn and has 9 to 30 mass % of Fe is present at 30 g/m² or more.

Elements such as Ni, Co, Mn, P, and B may be contained in a plating layer to further improve corrosion resistance and chemical conversion treatability, but even if these elements are contained, if Zn is the main component (for example, 60 mass % or more) and the Fe content is 9 to 30 mass %, the layer is a Γ layer.

The coating amount of the Γ-layer is obtained through the following method.

The measurement of the Γ layer which is mainly composed of Zn and contains 9 to 30 mass % of Fe is carried out through the following method. That is, the hot-stamped formed body is electrolyzed up to the Γ layer at a point where the potential changes significantly to −800 mVvs. SCE or less through constant current electrolysis using a saturated calomel electrode as a reference electrode at 4 mA/cm² in an aqueous solution of 150 g/L NH₄Cl, and the electrolytic solution is measured through ICP to specify the coating amount and chemical composition thereof.

For the measurement of the Zn—Fe alloy layer with more than 30 mass % of Fe, after electrolysis up to the above-described Γ layer, the electrolytic solution is replaced with a new solution and continuously electrolyzed up to the iron potential (about-560 mVvs. SCE), and the electrolytic solution is measured through ICP in the same manner.

In addition, in the hot-stamped formed body according to the present embodiment, when the maximum value of the B content in the plating layer in mass % is Bc and the B content in mass % at a position at ¼ depth of the base steel sheet is Bq, Be is 1.2 times or more Bq (Bc/Bq≥1.2).

By setting Be to 1.2 times or more Bq, the rust resistance of the hot-stamped formed body can be improved. Although the detailed mechanism is unknown, it is thought that this is because the presence of B in the plating layer suppresses the alloying reaction between Fe and Zn during hot stamping, enabling the Γ layer to be secured at 30 g/m² or more, and suppression of the non-uniform reaction between Fe and Zn in the plating layer suppresses the formation of unevenness in the plating layer. This effect is significant when the Bc/Bq is 1.2 or more, and therefore, the Bc/Bq is set to 1.2 or more. The Bc/Bq is desirably 1.3 or more, and more desirably 1.4 or more.

The Bc/Bq is obtained through the following method.

When measuring Bc, the maximum value Bc of B in the plating layer can be measured by cutting out a 50 mm×50 mm test piece from the formed body, and performing elemental analysis from the surface layer through glow discharge emission analysis (GDS). Whether the subject is a plating layer or a base material may be identified by referring to the Zn and Fe contents. The area where the Fe content in Zn is 9 to 30 mass % is defined as a Γ layer, and the maximum value of the B content in the plating layer in mass % is defined as Bc.

For the B content in mass % at a position at ¼ depth of the base steel sheet, a 50 mm wide×50 mm long test piece is cut out from the hot-stamped formed body, polishing is performed to the ¼ depth position of the base steel sheet, and then the B content is measured in mass % through GDS.

In the measurement, an average value of B contents within a range from a position of 10 μm to a position of 20 μm in the sheet thickness direction from the polished surface of the formed body is set to Bq. The B content is measured at these positions because the polished test specimen may have adherents on the surface and may lack quantification. However, if adherents can be removed, the average value of the B contents at positions of 0 to 10 μm from the polished surface can also be set to Bq. The average content in the range of 10 μm (10 to 20 μm, or 0 to 10 μm) in the sheet thickness direction is set to Bq to remove the influence of slight segregation formed during casting. On the other hand, while expanding the measurement range in the sheet thickness direction is advantageous in terms of accuracy, expanding the measurement range in the sheet thickness direction leads to longer measurement time. The measurement of elemental distribution in the sheet thickness direction through GDS should be limited to 100 μm because the larger the measurement area in the depth direction, the longer time is required.

### <Base Steel Sheet>

### <<Chemical Composition>>

The hot-stamped formed body according to the present embodiment is obtained by performing hot stamping on the steel sheet for hot-stamping according to the present embodiment as described above. Since the chemical composition of the base steel sheet is not substantially changed by hot stamping, the chemical composition of the base steel sheet of the hot-stamped formed body according to the present embodiment is the same as that of the base steel sheet of the steel sheet for hot-stamping according to the present embodiment in terms of range and limiting reasons.

### <<Microstructure>>

It is necessary for the microstructure of the hot-stamped formed body according to the present embodiment to be controlled according to the strength of a desired formed body. If the tensile strength of the hot-stamped formed body is set to 500 MPa or more, the microstructure may contain, in volume fraction, martensite: 5% to 100% and ferrite: 0% to 95% at a position at ¼ depth which is in a range of ⅛ to ⅜ of a sheet thickness in a sheet thickness direction from the surface of the base steel sheet, the remaining structure including bainite and/or pearlite. If the volume fraction of martensite is less than 5%, sufficient strength cannot be obtained.

If the tensile strength of the hot-stamped formed body is set to be in a range of 800 MPa or more (for example, 1,000 MPa or less), the martensite volume fraction is desirably set to 10% or more.

If the tensile strength of the hot-stamped formed body is set to be in a range of more than 1,000 MPa, the martensite volume fraction is desirably set to 80% or more, and more desirably set to 90% or more.

The remainder other than martensite and ferrite is one or more (one or two) of bainite and pearlite. The remainder may not be contained.

The microstructure and chemical composition of the base steel sheet of the hot-stamped formed body according to the present embodiment can be measured in the same manner as the microstructure and chemical composition of the base steel sheet of the steel sheet for hot-stamping according to the present embodiment.

As described above, since the hot-stamped formed body according to the present embodiment is obtained by hot stamping the steel sheet for hot-stamping in which B in the surface layer portion of the base steel sheet is concentrated on the surface and B concentrated on the surface is diffused in the plating layer, in the surface layer portion of the hot-stamped formed body, there may be an area in which the b content (concentration) has decreased.

Specifically, the B content at a position of 10 μm from the surface of the base steel sheet may be 80% or less of the B content at a position at ¼ depth of the sheet thickness of the base steel sheet.

### [Properties]

The strength of the hot-stamped formed body is not particularly specified, and excellent rust resistance can be secured.

However, since the major object of using the hot-stamped formed body is to secure a high-strength formed body, the tensile strength of the hot-stamped formed body is desirably set to 500 MPa or more. Depending on the application, the tensile strength of the hot-stamped formed body may be 800 MPa or more, 1,000 MPa or more or 1,200 MPa or more.

### [Method for Manufacturing Hot-Stamped Formed Body]

The hot-stamped formed body according to the present embodiment is obtained by performing hot stamping on the steel sheet for hot-stamping according to the present embodiment.

Although hot stamping conditions may be within the well-known range, the steel sheet for hot-stamping according to the present embodiment is less affected by heating conditions during hot stamping, and it is possible to apply following conditions, for example: heating at heating temperatures of 850° C. to 920° C. and heating time of 180 to 600 seconds, and then cooling to the martensitic transformation start temperature or less at an average cooling rate of 30° C./second or higher while forming.

The hot-stamped formed body may be cooled in a mold so that a strength is uniform in a formed body, or a portion of it may be air-cooled or slowly cooled in a mold installed along with a heater or the like at the same time as the cooling in a mold to create different strengths for different portions.

### EXAMPLES

Next, examples of the present invention will be described. However, the conditions in the examples are merely condition examples employed for confirming the feasibility and effect of the present invention, and the present invention is not limited to these condition examples. The present invention can adopt various conditions as long as the gist of the present invention is not deviated and the object of the present invention is achieved.

Slabs with the chemical compositions shown in Table 1 (units being mass %, the remainder being Fe and impurities) were cast.

Hot rolling was performed on these slabs under the conditions in Tables 2-1 and 2-2 to manufacture hot-rolled steel sheets with a sheet thickness of 4.0 mm. The hot-rolled steel sheets were coiled and uncoiled, pickling was then performed, and cold rolling was performed until the sheet thickness became 2.0 mm to manufacture cold-rolled steel sheets.

Thereafter, these cold-rolled steel sheets were then passed through a continuous hot-dip galvanizing line, annealed and plated to obtain steels sheet for hot-stamping. Specifically, the steel sheets were held in atmospheres shown in Tables 2-1 and 2-2 for 120 seconds, cooled at an average cooling rate of 1.6° C./second until the surface temperature reached 500° C. to 400° C., and then immersed in a plating bath with a bath temperature of 460° C. to form plating layers on the surfaces. In some steel sheets (they are described as galvannealed steel sheets: GA in Examples), plating layer was changed to galvannealed layer by heating to 500 to 560° C. after plating. Thereafter, the steel sheets were cooled to 50° C. or lower.

Chemical compositions of the plating layers and microstructures of the base steel sheets of the obtained steel sheet for hot-stamping were measured through the above-described methods.

Results are shown in Tables 2-3 and 2-4. The remainder of the chemical composition of the plating layer except for B, Fe, and Al was Zn and impurities including Mn, Si, Cr, and Ti that were mixed in from the steel sheets.

TABLE 1

| Steel | | | | | | | | | | | | |
|---|---|---|---|---|---|---|---|---|---|---|---|---|
| type | C | Si | Mn | P | S | Al | Ti | B | N | O | Others | Remarks |
| A | 0.079 | 0.79 | 2.49 | 0.019 | 0.0029 | 0.031 | 0.044 | 0.0016 | 0.0039 | 0.0019 | — | Steel of the invention |
| B | 0.156 | 0.19 | 1.96 | 0.016 | 0.0026 | 0.016 | 0.016 | 0.0019 | 0.0031 | 0.0023 | — | Steel of the |
| | | | | | | | | | | | | invention |
| C | 0.221 | 0.22 | 1.29 | 0.011 | 0.0028 | 0.019 | 0.024 | 0.0024 | 0.0030 | 0.0020 | Cr = 0.18 | Steel of the |
| | | | | | | | | | | | | invention |
| D | 0.310 | 0.19 | 1.33 | 0.011 | 0.0019 | 0.007 | 0.019 | 0.0016 | 0.0026 | 0.0018 | Cr = 0.24, | Steel of the |
| | | | | | | | | | | | Nb = 0.042 | invention |
| E | 0.368 | 0.01 | 0.49 | 0.009 | 0.0006 | 0.033 | 0.021 | 0.0016 | 0.0027 | 0.0023 | Ni = 0.78, | Steel of the |
| | | | | | | | | | | | Cu = 0.23 | invention |
| F | 0.441 | 0.18 | 0.33 | 0.003 | 0.0007 | 0.026 | 0.022 | 0.0015 | 0.0030 | 0.0016 | Cr = 0.16, | Steel of the |
| | | | | | | | | | | | Cu = 0.17 | invention |
| G | 0.216 | 0.22 | 0.45 | 0.011 | 0.0016 | 0.024 | 0.026 | 0.0019 | 0.0016 | 0.0025 | V = 0.023 | Steel of the |
| | | | | | | | | | | | | invention |
| H | 0.221 | 0.21 | 1.29 | 0.008 | 0.0019 | 0.031 | 0.019 | 0.0028 | 0.0033 | 0.0030 | W = 0.019 | Steel of the |
| | | | | | | | | | | | | invention |
| I | 0.230 | 0.19 | 1.34 | 0.007 | 0.0022 | 0.029 | 0.020 | 0.0017 | 0.0016 | 0.0027 | Cr = 0.88 | Steel of the |
| | | | | | | | | | | | | invention |
| J | 0.201 | 0.20 | 1.45 | 0.006 | 0.0028 | 0.026 | 0.022 | 0.0026 | 0.0023 | 0.0024 | Mo = 0.09 | Steel of the |
| | | | | | | | | | | | | invention |
| K | 0.230 | 0.26 | 1.99 | 0.010 | 0.0016 | 0.025 | 0.021 | 0.0021 | 0.0020 | 0.0023 | Co = 0.011 | Steel of the |
| | | | | | | | | | | | | invention |
| L | 0.252 | 0.14 | 2.03 | 0.009 | 0.0009 | 0.024 | 0.024 | 0.0020 | 0.0017 | 0.0021 | Ni = 0.24, | Steel of the |
| | | | | | | | | | | | Cu = 0.09 | invention |
| M | 0.231 | 0.19 | 1.98 | 0.011 | 0.0012 | 0.018 | 0.022 | 0.0011 | 0.0029 | 0.0028 | REM = 0.0051 | Steel of the |
| | | | | | | | | | | | | invention |
| N | 0.229 | 0.02 | 2.23 | 0.011 | 0.0023 | 0.024 | 0.025 | 0.0016 | 0.0019 | 0.0009 | Zr = 0.0245 | Steel of the |
| | | | | | | | | | | | | invention |
| O | 0.241 | 0.22 | 2.44 | 0.007 | 0.0019 | 0.045 | 0.020 | 0.0036 | 0.0031 | 0.0019 | Ca = 0.0073 | Steel of the |
| | | | | | | | | | | | | invention |
| P | 0.227 | 0.19 | 2.09 | 0.007 | 0.0020 | 0.032 | 0.023 | 0.0024 | 0.0022 | 0.0029 | Mg = 0.0077 | Steel of the |
| | | | | | | | | | | | | invention |
| Q | 0.236 | 0.23 | 1.96 | 0.021 | 0.0024 | 0.023 | 0.024 | 0.0026 | 0.0029 | 0.0023 | As = 0.088 | Steel of the |
| | | | | | | | | | | | | invention |
| R | 0.262 | 0.39 | 2.07 | 0.019 | 0.0019 | 0.030 | 0.028 | 0.0021 | 0.0030 | 0.0024 | Sn = 0.39 | Steel of the |
| | | | | | | | | | | | | invention |
| S | 0.216 | 0.10 | 2.01 | 0.016 | 0.0005 | 0.088 | 0.021 | 0.0023 | 0.0019 | 0.0020 | Sb = 0.42 | Steel of the |
| | | | | | | | | | | | | invention |
| T | 0.229 | 0.29 | 2.09 | 0.009 | 0.0014 | 0.024 | 0.037 | 0.0059 | 0.0026 | 0.0011 | — | Steel of the |
| | | | | | | | | | | | | invention |
| a | 0.232 | 0.23 | 1.29 | 0.011 | 0.0023 | 0.026 | 0.019 | 0.0000 | 0.0040 | 0.0035 | Cr = 0.23 | Comparative |
| | | | | | | | | | | | | steel |
| b | 0.229 | 0.24 | 1.36 | 0.019 | 0.0017 | 0.033 | 0.013 | 0.0113 | 0.0029 | 0.0026 | — | Comparative |
| | | | | | | | | | | | | steel |
| c | 0.021 | 0.22 | 1.30 | 0.023 | 0.0019 | 0.019 | 0.029 | 0.0023 | 0.0022 | 0.0019 | — | Comparative |
| | | | | | | | | | | | | steel |
| d | 0.632 | 0.16 | 1.33 | 0.009 | 0.0023 | 0.014 | 0.045 | 0.0019 | 0.0029 | 0.0023 | — | Comparative |
| | | | | | | | | | | | | steel |
| e | 0.234 | 1.63 | 1.32 | 0.013 | 0.0026 | 0.015 | 0.016 | 0.0015 | 0.0033 | 0.0027 | Cr = 0.18 | Comparative |
| | | | | | | | | | | | | steel |
| f | 0.223 | 0.23 | 0.04 | 0.011 | 0.0030 | 0.011 | 0.023 | 0.0025 | 0.0019 | 0.0033 | — | Comparative |
| | | | | | | | | | | | | steel |
| g | 0.219 | 0.22 | 3.46 | 0.010 | 0.0009 | 0.072 | 0.027 | 0.0032 | 0.0022 | 0.0006 | — | Comparative |
| | | | | | | | | | | | | steel |
| h | 0.196 | 0.20 | 1.32 | 0.119 | 0.0011 | 0.008 | 0.031 | 0.0019 | 0.0029 | 0.0029 | — | Comparative |
| | | | | | | | | | | | | steel |
| i | 0.223 | 0.37 | 1.19 | 0.016 | 0.0105 | 0.037 | 0.017 | 0.0034 | 0.0027 | 0.0034 | — | Comparative |
| | | | | | | | | | | | | steel |
| j | 0.224 | 0.21 | 1.45 | 0.022 | 0.0019 | 0.041 | 0.007 | 0.0017 | 0.0026 | 0.0029 | — | Comparative |
| | | | | | | | | | | | | steel |
| k | 0.241 | 0.22 | 1.33 | 0.015 | 0.0028 | 0.011 | 0.109 | 0.0021 | 0.0031 | 0.0024 | — | Comparative |
| | | | | | | | | | | | | steel |
| l | 0.223 | 0.26 | 1.45 | 0.009 | 0.0024 | 0.019 | 0.025 | 0.0018 | 0.0186 | 0.0027 | — | Comparative |
| | | | | | | | | | | | | steel |
| m | 0.219 | 0.29 | 1.24 | 0.013 | 0.0018 | 0.124 | 0.022 | 0.0027 | 0.0024 | 0.0016 | — | Comparative |
| | | | | | | | | | | | | steel |

Underlined parts mean outside the scope of the present invention.
“—” means that each element is not added.

TABLE 2-1
Steel sheet for hot-stamping

| | | Manufacturing condition | | | | | |
|---|---|---|---|---|---|---|---|
| | | Hot rolling process | | Coiling | | | |
| | | | Finish | process | Annealing process | | Subjected or Not- |
| Steel | | Heating | rolling | Coiling | Atmospheric | | subjected to |
| sheet | Steel | temperature | temperature | temperature | temperature | Oxygen | alloying heat |
| No. | type | (° C.) | (° C.) | (° C.) | (° C.) | potential | treatment |
| A-1 | A | 1200 | 940 | 530 | 740 | −0.78 | Subjected |
| B-1 | B | 1220 | 940 | 540 | 690 | −0.64 | Subjected |
| C-1 | C | 1210 | 940 | 510 | 740 | −0.82 | Subjected |
| C-2 | C | 1190 | 940 | 500 | 720 | −0.78 | Not-subjected |
| C-3 | C | 1240 | 940 | 500 | 730 | −0.70 | Subjected |
| C-4 | C | 1220 | 940 | 450 | 730 | −0.66 | Subjected |
| C-5 | C | 1200 | 940 | 500 | 730 | −0.64 | Subjected |
| C-6 | C | 1210 | 940 | 500 | 740 | −0.72 | Subjected |
| C-7 | C | 1180 | 940 | 680 | 720 | −0.72 | Subjected |
| C-8 | C | 1260 | 940 | 540 | 800 | −0.76 | Subjected |
| C-9 | C | 1220 | 940 | 500 | 720 | −2.98 | Subjected |
| C-10 | C | 1190 | 900 | 470 | 650 | −0.54 | Subjected |
| C-11 | C | 1240 | 960 | 520 | 795 | −0.58 | Subjected |
| C-12 | C | 1220 | 910 | 490 | 750 | −0.60 | Subjected |
| C-13 | C | 1230 | 970 | 500 | 740 | −0.58 | Subjected |
| D-1 | D | 1200 | 940 | 490 | 740 | −0.62 | Subjected |
| D-2 | D | 1210 | 940 | 540 | 730 | −0.76 | Not-subjected |
| D-3 | D | 1230 | 940 | 540 | 750 | −0.72 | Subjected |
| D-4 | D | 1200 | 940 | 560 | 720 | −0.65 | Subjected |
| D-5 | D | 1200 | 940 | 530 | 740 | −0.65 | Subjected |
| D-6 | D | 1180 | 940 | 550 | 720 | −0.71 | Subjected |
| D-7 | D | 1220 | 940 | 710 | 740 | −0.83 | Subjected |
| D-8 | D | 1200 | 940 | 530 | 810 | −1.03 | Subjected |
| D-9 | D | 1230 | 940 | 470 | 740 | −1.89 | Subjected |
| D-10 | D | 1260 | 920 | 510 | 650 | −0.61 | Subjected |
| D-11 | D | 1210 | 910 | 490 | 790 | −0.65 | Subjected |
| E-1 | E | 1250 | 940 | 500 | 730 | −0.72 | Subjected |
| E-2 | E | 1200 | 940 | 530 | 740 | −0.88 | Not-subjected |
| E-3 | E | 1190 | 940 | 670 | 720 | −0.84 | Subjected |
| E-4 | E | 1180 | 940 | 500 | 830 | −0.93 | Subjected |
| E-5 | E | 1220 | 940 | 550 | 730 | −1.32 | Subjected |

Underlined parts mean outside the scope of the present invention.

TABLE 2-2
Steel sheet for hot-stamping

| | | Manufacturing condition | | | | | |
|---|---|---|---|---|---|---|---|
| | | Hot rolling process | | | | | |
| | | | Finish | Coiling process | Annealing process | | Subjected or Not- |
| Steel | | Heating | rolling | Coiling | Atmospheric | | subjected to |
| sheet | Steel | temperature | temperature | temperature | temperature | Oxygen | alloying heat |
| No. | type | (° C.) | (° C.) | (° C.) | (° C.) | potential | treatment |
| F-1 | F | 1200 | 940 | 540 | 740 | −1.12 | Subjected |
| G-1 | G | 1200 | 940 | 530 | 720 | −0.65 | Subjected |
| H-1 | H | 1210 | 940 | 590 | 740 | −0.54 | Subjected |
| I-1 | I | 1210 | 940 | 510 | 710 | −0.68 | Subjected |
| J-1 | J | 1200 | 940 | 500 | 750 | −0.72 | Subjected |
| K-1 | K | 1240 | 940 | 440 | 740 | −0.75 | Subjected |
| L-1 | L | 1260 | 940 | 530 | 720 | −0.72 | Subjected |
| M-1 | M | 1180 | 940 | 540 | 740 | −0.64 | Subjected |
| N-1 | N | 1200 | 940 | 550 | 740 | −0.82 | Subjected |
| O-1 | O | 1200 | 940 | 590 | 730 | −0.70 | Subjected |
| P-1 | P | 1210 | 940 | 540 | 720 | −0.62 | Subjected |
| Q-1 | Q | 1230 | 940 | 530 | 730 | −0.64 | Subjected |
| R-1 | R | 1220 | 940 | 500 | 730 | −0.75 | Subjected |
| S-1 | S | 1220 | 940 | 500 | 720 | −0.74 | Subjected |
| T-1 | T | 1240 | 980 | 520 | 790 | −0.52 | Not-subjected |
| a-1 | a | 1200 | 940 | 460 | 740 | −0.72 | Subjected |
| b-1 | b | 1160 | 940 | 560 | 730 | −0.92 | Subjected |
| c-1 | c | 1200 | 940 | 590 | 720 | −0.81 | Subjected |
| d-1 | d | 1240 | 940 | 430 | 750 | −0.72 | Subjected |
| e-1 | e | 1200 | 940 | 530 | 740 | −0.66 | Subjected |
| f-1 | f | 1210 | 940 | 540 | 740 | −0.81 | Subjected |
| g-1 | g | 1210 | 940 | 530 | —*2 | —*2 | —*2 |
| h-1 | h | 1200 | 940 | 560 | —*2 | —*2 | —*2 |
| i-1 | i | 1220 | 940 | 580 | —*2 | —*2 | —*2 |
| j-1 | j | 1230 | 940 | 550 | 740 | −0.72 | Subjected |
| k-1 | k | 1220 | 940 | 570 | 740 | −0.70 | Subjected |
| l-1 | l | 1200 | 940 | 530 | 720 | −0.76 | Subjected |
| m-1 | m | 1210 | 940 | 530 | 740 | −0.64 | Subjected |

Underlined parts mean outside the scope of the present invention.
*2means that cold rolling could not be performed and the sheet could not pass through the subsequent process.

TABLE 2-3
Steel sheet for hot-stamping

| | | Base steel sheet | | | | Galvanized layer | | | | |
|---|---|---|---|---|---|---|---|---|---|---|
| | | | | | B content at position | | | | | |
| | | | | | of 10 μm from | Chemical | | | | |
| | Steel | | | | interface with | composition | | | | |
| Steel | sheet | microstructure | | | plating layer/ B | (mass %) | | | Coating | |
| sheet | type | Ferrite | Pearlite | Others | content at position | B | Fe | Al | amount | |
| No. | *3 | (vol. %) | (vol. %) | (vol. %) | at ¼ depth | (%) | (%) | (%) | (g/m²) | Remarks |
| A-1 | GA | 91 | 5 | bainite: | 0.61 | 0.0013 | 13.0 | 0.20 | 59 | Example of |
| | | | | 4 | | | | | | the invention |
| B-1 | GA | 80 | 20 | — | 0.60 | 0.0014 | 12.0 | 0.18 | 60 | Example of |
| | | | | | | | | | | the invention |
| C-1 | GA | 71 | 29 | — | 0.62 | 0.0019 | 12.0 | 0.22 | 62 | Example of |
| | | | | | | | | | | the invention |
| C-2 | GI | 80 | 20 | — | 0.61 | 0.0020 | 3.0 | 0.11 | 59 | Example of |
| | | | | | | | | | | the invention |
| C-3 | GA | 79 | 21 | — | 0.59 | 0.0016 | 12.0 | 0.22 | 54 | Example of |
| | | | | | | | | | | the invention |
| C-4 | GA | 77 | 23 | — | 0.58 | 0.0019 | 11.0 | 0.16 | 60 | Example of |
| | | | | | | | | | | the invention |
| C-5 | GA | 78 | 22 | — | 0.54 | 0.0020 | 13.0 | 0.22 | 59 | Example of |
| | | | | | | | | | | the invention |
| C-6 | GA | 78 | 22 | — | 0.90 | 0.0018 | 10.0 | 0.13 | 24 | Comparative |
| | | | | | | | | | | example |
| C-7 | GA | 77 | 23 | — | 0.99 | 0.0004 | 9.0 | 0.14 | 54 | Comparative |
| | | | | | | | | | | example |
| C-8 | GA | 79 | 21 | — | 0.89 | 0.0004 | 10.0 | 0.24 | 53 | Comparative |
| | | | | | | | | | | example |
| C-9 | GA | 80 | 20 | — | 0.99 | 0.0002 | 11.0 | 0.09 | 55 | Comparative |
| | | | | | | | | | | example |
| C-10 | GA | 78 | 22 | — | 0.69 | 0.0011 | 11.9 | 0.17 | 64 | Example of |
| | | | | | | | | | | the invention |
| C-11 | GA | 72 | 25 | bainite: | 0.72 | 0.0009 | 10.6 | 0.19 | 50 | Example of |
| | | | | 3 | | | | | | the invention |
| C-12 | GA | 74 | 26 | — | 0.71 | 0.0013 | 14.3 | 0.13 | 46 | Example of |
| | | | | | | | | | | the invention |
| C-13 | GA | 76 | 24 | — | 0.49 | 0.0017 | 10.9 | 0.21 | 35 | Example of |
| | | | | | | | | | | the invention |
| D-1 | GA | 63 | 37 | — | 0.55 | 0.0012 | 11.0 | 0.23 | 56 | Example of |
| | | | | | | | | | | the invention |
| D-2 | GI | 64 | 36 | — | 0.60 | 0.0011 | 4.0 | 0.14 | 59 | Example of |
| | | | | | | | | | | the invention |
| D-3 | GA | 64 | 36 | — | 0.54 | 0.0014 | 10.0 | 0.24 | 62 | Example of |
| | | | | | | | | | | the invention |
| D-4 | GA | 65 | 35 | — | 0.58 | 0.0010 | 12.0 | 0.20 | 60 | Example of |
| | | | | | | | | | | the invention |
| D-5 | GA | 64 | 36 | — | 0.61 | 0.0013 | 11.0 | 0.19 | 56 | Example of |
| | | | | | | | | | | the invention |
| D-6 | GA | 64 | 36 | — | 0.89 | 0.0014 | 12.0 | 0.22 | 26 | Comparative |
| | | | | | | | | | | example |
| D-7 | GA | 64 | 36 | — | 1.00 | 0.0004 | 12.0 | 0.17 | 68 | Comparative |
| | | | | | | | | | | example |
| D-8 | GA | 63 | 37 | — | 0.97 | 0.0003 | 10.0 | 0.20 | 62 | Comparative |
| | | | | | | | | | | example |
| D-9 | GA | 65 | 35 | — | 0.99 | 0.0001 | 11.0 | 0.16 | 59 | Comparative |
| | | | | | | | | | | example |
| D-10 | GA | 67 | 33 | — | 0.66 | 0.0010 | 9.2 | 0.16 | 62 | Example of |
| | | | | | | | | | | the invention |
| D-11 | GA | 61 | 39 | — | 0.75 | 0.0007 | 11.8 | 0.21 | 54 | Example of |
| | | | | | | | | | | the invention |
| E-1 | GA | 55 | 45 | — | 0.62 | 0.0013 | 9.0 | 0.31 | 60 | Example of |
| | | | | | | | | | | the invention |
| E-2 | GI | 54 | 46 | — | 0.68 | 0.0014 | 2.0 | 0.12 | 62 | Example of |
| | | | | | | | | | | the invention |
| E-3 | GA | 55 | 45 | — | 0.98 | 0.0003 | 10.0 | 0.16 | 61 | Comparative |
| | | | | | | | | | | example |
| E-4 | GA | 55 | 45 | — | 1.00 | 0.0003 | 11.0 | 0.19 | 63 | Comparative |
| | | | | | | | | | | example |
| E-5 | GA | 54 | 46 | — | 0.99 | 0.0001 | 12.0 | 0.15 | 58 | Comparative |
| | | | | | | | | | | example |

TABLE 2-4
Steel sheet for hot-stamping

| | | Base steel sheet | | | | Galvanized layer | | | | |
|---|---|---|---|---|---|---|---|---|---|---|
| | | | | | B content at | | | | | |
| | | | | | position of 10 μm | Chemical | | | | |
| | Steel | | | | from interface with | composition | | | | |
| Steel | sheet | microstructure | | | plating layer/B | (mass %) | | | Coating | |
| sheet | type | Ferrite | Pearlite | Others | content at position | B | Fe | Al | weight | |
| No. | *3 | (vol. %) | (vol. %) | (vol. %) | at ¼ depth | (%) | (%) | (%) | (g/m²) | Remarks |
| F-1 | GA | 42 | 58 | — | 0.76 | 0.0011 | 10.0 | 0.21 | 60 | Example of |
| | | | | | | | | | | the |
| | | | | | | | | | | invention |
| G-1 | GA | 81 | 19 | — | 0.53 | 0.0016 | 11.0 | 0.19 | 64 | Example of |
| | | | | | | | | | | the |
| | | | | | | | | | | invention |
| H-1 | GA | 78 | 22 | — | 0.52 | 0.0019 | 12.0 | 0.22 | 63 | Example of |
| | | | | | | | | | | the |
| | | | | | | | | | | invention |
| I-1 | GA | 78 | 22 | — | 0.56 | 0.0013 | 10.0 | 0.31 | 60 | Example of |
| | | | | | | | | | | the |
| | | | | | | | | | | invention |
| J-1 | GA | 82 | 18 | — | 0.59 | 0.0022 | 10.0 | 0.25 | 59 | Example of |
| | | | | | | | | | | the |
| | | | | | | | | | | invention |
| K-1 | GA | 78 | 22 | — | 0.52 | 0.0019 | 12.0 | 0.22 | 56 | Example of |
| | | | | | | | | | | the |
| | | | | | | | | | | invention |
| L-1 | GA | 74 | 26 | — | 0.63 | 0.0017 | 11.0 | 0.19 | 56 | Example of |
| | | | | | | | | | | the |
| | | | | | | | | | | invention |
| M-1 | GA | 79 | 21 | — | 0.55 | 0.0010 | 10.0 | 0.27 | 60 | Example of |
| | | | | | | | | | | the |
| | | | | | | | | | | invention |
| N-1 | GA | 77 | 23 | — | 0.59 | 0.0012 | 12.0 | 0.22 | 57 | Example of |
| | | | | | | | | | | the |
| | | | | | | | | | | invention |
| O-1 | GA | 76 | 24 | — | 0.62 | 0.0016 | 13.0 | 0.26 | 53 | Example of |
| | | | | | | | | | | the |
| | | | | | | | | | | invention |
| P-1 | GA | 77 | 23 | — | 0.57 | 0.0021 | 14.0 | 0.20 | 59 | Example of |
| | | | | | | | | | | the |
| | | | | | | | | | | invention |
| Q-1 | GA | 77 | 23 | — | 0.55 | 0.0023 | 16.0 | 0.24 | 54 | Example of |
| | | | | | | | | | | the |
| | | | | | | | | | | invention |
| R-1 | GA | 71 | 29 | — | 0.53 | 0.0018 | 9.0 | 0.19 | 60 | Example of |
| | | | | | | | | | | the |
| | | | | | | | | | | invention |
| S-1 | GA | 79 | 21 | — | 0.60 | 0.0020 | 9.0 | 0.21 | 53 | Example of |
| | | | | | | | | | | the |
| | | | | | | | | | | invention |
| T-1 | GI | 74 | 26 | — | 0.76 | 0.0054 | 8.4 | 0.22 | 53 | Example of |
| | | | | | | | | | | the |
| | | | | | | | | | | invention |
| a-1 | GA | 77 | 23 | — | — | 0.0000 | 12.0 | 0.24 | 57 | Comparative |
| | | | | | | | | | | example |
| b-1 | GA | 78 | 22 | — | 0.96 | 0.0003 | 11.0 | 0.16 | 48 | Comparative |
| | | | | | | | | | | example |
| c-1 | GA | 100 | 0 | — | 0.63 | 0.0016 | 10.0 | 0.22 | 55 | Comparative |
| | | | | | | | | | | example |
| d-1 | GA | 8 | 92 | — | 0.63 | 0.0011 | 12.0 | 0.21 | 56 | Comparative |
| | | | | | | | | | | example |
| e-1 | GA | 76 | 24 | — | 0.60 | 0.0008 | 11.0 | 0.19 | 58 | Comparative |
| | | | | | | | | | | example |
| f-1 | GA | 88 | 12 | — | 0.65 | 0.0012 | 11.0 | 0.21 | 51 | Comparative |
| | | | | | | | | | | example |
| g-1 | —*2 | —*2 | —*2 | —*2 | —*2 | —*2 | —*2 | —*2 | —*2 | Comparative |
| | | | | | | | | | | example |
| h-1 | —*2 | —*2 | —*2 | —*2 | —*2 | —*2 | —*2 | —*2 | —*2 | Comparative |
| | | | | | | | | | | example |
| i-1 | —*2 | —*2 | —*2 | —*2 | —*2 | —*2 | —*2 | —*2 | —*2 | Comparative |
| | | | | | | | | | | example |
| j-1 | GA | 77 | 23 | — | 0.98 | 0.0009 | 11.0 | 0.20 | 55 | Comparative |
| | | | | | | | | | | example |
| k-1 | GA | 75 | 25 | — | 0.96 | 0.0012 | 9.0 | 0.24 | 49 | Comparative |
| | | | | | | | | | | example |
| l-1 | GA | 78 | 22 | — | 0.99 | 0.0010 | 10.0 | 0.22 | 53 | Comparative |
| | | | | | | | | | | example |
| m-1 | GA | 78 | 22 | — | 0.54 | 0.0012 | 10.0 | 0.23 | 60 | Comparative |
| | | | | | | | | | | example |

Underlined parts mean outside the scope of the present invention.
*2means that cold rolling could not be performed and the sheet could not pass through the subsequent process.
*3means that GA represents galvannealed steel sheet and GI represents galvanized steel sheet.

Hot stamping was performed on these steel sheets for hot-stamping (A-1 to m-1).

For hot stamping, as shown in Tables 3-1 to 3-2, two samples were prepared for each example and inserted into an atmospheric furnace with a furnace temperature of 860° C. to 940° C. After performing two types of heating, one for 6 minutes and the other for 9 minutes, each was taken out from the furnace and quenched (cooled to the martensitic transformation start temperature or less at an average cooling rate of 30° C./second or higher) using a mold. Accordingly, a hot-stamped formed body was obtained.

The coating amount of the Γ layer and the microstructure of the base steel sheet of each of these hot-stamped formed bodies were measured through the above-described method. In addition, the maximum value of the B content of a plating layer was measured through the above-described method and a Bc/Bq is obtained. Results are shown in Tables 3-1 and 3-2. However, the tables show results of test pieces heated for 9 minutes as an example, except for the coating amount of the T-layer.

In addition, the tensile strength and rust resistance of the hot-stamped formed bodies in the case of 9-minute heating, which is a stricter evaluation, were evaluated as follows.

### [Tensile Strength]

No. 5 test pieces of JIS Z 2241:2011 were cut out from the obtained hot-stamped formed bodies and tensile tests were conducted in accordance with JIS Z 2241:2011. The crosshead speed in the tensile test was performed under the conditions that the strain rate was constant at 0.005 s⁻¹.

It was determined that a tensile strength of 500 MPa or more would satisfy the assumed target value.

### [Rust Resistance]

### (Corrosion Resistance)

A 70 mm×150 mm sample was taken from each of the manufactured hot-stamped formed bodies. After degreasing its surface, the surface was subjected to chemical conversion treatment with Palbond LA35 (manufactured by Nihon Parkerizing Co., Ltd.) and coated with 15 μm of cationic electrodeposition coating (Powernix 110: manufactured by Nippon Paint Co., Ltd.), and then cross-cutting was carried out.

The width of blister in the coating film (one side) from the cross-cut area was measured for this test piece after 300 cycles under the corrosion test conditions specified in the standard SAE-J2334 of the American Automobile Manufacturers Association. A sample with a width of blister of 10 mm or less was determined to have excellent corrosion resistance.

### [Rust Resistance]

### (Adhesion of Coating Film)

A 70 mm×150 mm sample was taken from each of the manufactured hot-stamped formed bodies. After degreasing its surface, the surface was subjected to chemical conversion treatment with Palbond LA35 (manufactured by Nihon Parkerizing Co., Ltd.), and cationic electrodeposition coating (Powernix 110: manufactured by Nippon Paint Co., Ltd.) was applied thereto to form a 15-μm thick coating film.

This test piece was subjected to a warm salt water immersion test to evaluate the adhesion of coating film. For the warm salt water immersion test, the sample was subjected to chemical conversion treatment and electrodeposition coating, and then 45-mm long cross-cut scratches were made using a cutter. The sample was then immersed in a 5% NaCl solution at 60° C. for 240 hours, and after immersion, washed with water, and dried.

After adhesive tape was pasted on the cut scratches of the dried sample, the tape was peeled off, and the maximum full width of peeling, which was the maximum value of the width of the peeled coating film in the direction perpendicular to the length. direction of the cut scratches, was measured.

A sample having a maximum full width of peeling of 5 mm or less was determined to have favorable resistance to warm salt water adhesion (adhesion of coating film).

TABLE 3-1
Hot-stamped formed body

| | | Hot stamping | | | | Plating layer | | |
|---|---|---|---|---|---|---|---|---|
| | | conditions | Microstructure of hot-stamped | | | Coating amount of Γ | | |
| | Material | Heating | formed body | | | layer (g/m²) | | |
| Formed | steel | temperature | | | Others | In case of | In case of | |
| body | sheet | during hot | Martensite | Ferrite | (type: | heating for | heating for | |
| No. | No. | stamping (° C.) | (volume %) | (volume %) | volume %) | 6 minutes | 9 minutes | Bc/Bq |
| XA-1 | A-1 | 890 | 67 | 33 | — | 39 | 31 | 1.6 |
| XB-1 | B-1 | 890 | 100 | — | — | 40 | 32 | 1.7 |
| XC-1 | C-1 | 890 | 100 | — | — | 42 | 32 | 1.6 |
| XC-2 | C-2 | 890 | 100 | — | — | 39 | 31 | 1.6 |
| XC-3 | C-3 | 890 | 100 | — | — | 38 | 30 | 1.6 |
| XC-4 | C-4 | 890 | 100 | — | — | 40 | 33 | 1.7 |
| XC-5 | C-5 | 920 | 100 | — | — | 41 | 32 | 1.8 |
| XC-6 | C-6 | 860 | 100 | — | — | 21 | 16 | 1.1 |
| XC-7 | C-7 | 890 | 100 | — | — | 26 | 14 | 1.0 |
| XC-8 | C-8 | 890 | 100 | — | — | 31 | 23 | 1.1 |
| XC-9 | C-9 | 890 | 100 | — | — | 13 | 6 | 0.7 |
| XC-10 | C-10 | 900 | 100 | — | — | 38 | 32 | 1.5 |
| XC-11 | C-11 | 890 | 100 | — | — | 40 | 33 | 1.3 |
| XC-12 | C-12 | 940 | 100 | — | — | 46 | 32 | 1.7 |
| XC-13 | C-13 | 860 | 100 | — | — | 34 | 31 | 1.9 |
| XD-1 | D-1 | 890 | 100 | — | — | 39 | 31 | 1.8 |
| XD-2 | D-2 | 890 | 100 | — | — | 39 | 31 | 1.6 |
| XD-3 | D-3 | 890 | 100 | — | — | 41 | 33 | 1.7 |
| XD-4 | D-4 | 890 | 100 | — | — | 39 | 32 | 1.7 |
| XD-5 | D-5 | 920 | 100 | — | — | 39 | 31 | 1.6 |
| XD-6 | D-6 | 850 | 100 | — | — | 23 | 16 | 1.1 |
| XD-7 | D-7 | 890 | 100 | — | — | 27 | 13 | 0.9 |
| XD-8 | D-8 | 890 | 100 | — | — | 31 | 16 | 1.0 |
| XD-9 | D-9 | 890 | 100 | — | — | 19 | 7 | 0.8 |
| XD-10 | D-10 | 900 | 100 | — | — | 40 | 31 | 1.5 |
| XD-11 | D-11 | 880 | 100 | — | — | 39 | 31 | 1.4 |
| XE-1 | E-1 | 890 | 100 | — | — | 41 | 33 | 1.6 |
| XE-2 | E-2 | 890 | 100 | — | — | 38 | 31 | 1.4 |
| XE-3 | E-3 | 890 | 100 | — | — | 24 | 19 | 1.0 |
| XE-4 | E-4 | 890 | 100 | — | — | 34 | 20 | 1.1 |
| XE-5 | E-5 | 890 | 100 | — | — | 19 | 8 | 0.9 |

Underlined parts mean outside the scope of the present invention.

TABLE 3-2
Hot-stamped formed body

| | | Hot stamping | | | | Plating layer | | |
|---|---|---|---|---|---|---|---|---|
| | | conditions | Microstructure of hot-stamped | | | Coating amount of Γ | | |
| | Material | Heating | formed body | | | layer (g/m²) | | |
| Formed | steel | temperature | | | Others | In case of | In case of | |
| body | sheet | during hot | Martensite | Ferrite | (type: | heating for | heating for | |
| No. | No. | stamping (° C.) | (volume %) | (volume %) | volume %) | 6 minutes | 9 minutes | Bc/Bq |
| XF-1 | F-1 | 890 | 100 | — | — | 38 | 30 | 1.3 |
| XG-1 | G-1 | 890 | 100 | — | — | 42 | 35 | 1.8 |
| XH-1 | H-1 | 890 | 100 | — | — | 41 | 35 | 1.9 |
| XI-1 | I-1 | 890 | 100 | — | — | 40 | 30 | 1.7 |
| XJ-1 | J-1 | 890 | 100 | — | — | 38 | 32 | 1.7 |
| XK-1 | K-1 | 890 | 100 | — | — | 38 | 31 | 1.7 |
| XL-1 | L-1 | 890 | 100 | — | — | 37 | 32 | 1.6 |
| XM-1 | M-1 | 890 | 100 | — | — | 39 | 33 | 1.8 |
| XN-1 | N-1 | 890 | 100 | — | — | 38 | 32 | 1.6 |
| XO-1 | O-1 | 890 | 100 | — | — | 37 | 30 | 1.6 |
| XP-1 | P-1 | 890 | 100 | — | — | 38 | 32 | 1.7 |
| XQ-1 | Q-1 | 890 | 100 | — | — | 37 | 32 | 1.8 |
| XR-1 | R-1 | 890 | 100 | — | — | 39 | 33 | 1.7 |
| XS-1 | S-1 | 890 | 100 | — | — | 36 | 31 | 1.6 |
| XT-1 | T-1 | 880 | 100 | — | — | 45 | 36 | 1.3 |
| Xa-1 | a-1 | 890 | 7 | 89 | bainite: | 24 | 11 | — |
| | | | | | 4 | | | |
| Xb-1 | b-1 | 890 | 84 | 16 | — | 26 | 17 | 0.6 |
| Xc-1 | c-1 | 890 | 0 | 100 | — | 37 | 33 | 1.5 |
| Xd-1 | d-1 | 890 | 100 | — | — | 38 | 33 | 1.6 |
| Xe-1 | e-1 | 890 | 100 | — | — | 38 | 32 | 1.7 |
| Xf-1 | f-1 | 890 | 0 | 92 | pearlite: | 36 | 31 | 1.5 |
| | | | | | 8 | | | |
| Xg-1 | g-1 | —*2 | —*2 | —*2 | —*2 | —*2 | —*2 | —*2 |
| Xh-1 | h-1 | —*2 | —*2 | —*2 | —*2 | —*2 | —*2 | —*2 |
| Xi-1 | i-1 | —*2 | —*2 | —*2 | —*2 | —*2 | —*2 | —*2 |
| Xj-1 | j-1 | 890 | 8 | 64 | bainite: | 30 | 23 | 0.8 |
| | | | | | 28 | | | |
| Xk-1 | k-1 | 890 | 100 | 0 | | 34 | 26 | 0.7 |
| Xl-1 | l-1 | 890 | 6 | 45 | bainite: | 29 | 18 | 0.7 |
| | | | | | 49 | | | |
| Xm-1 | m-1 | 890 | 0 | 78 | pearlite: | 37 | 33 | 1.7 |
| | | | | | 22 | | | |

Underlined parts mean outside the scope of the present invention.
*2means that cold rolling could not be performed and the sheet could not pass through the subsequent process.

TABLE 3-3
Hot-stamped formed body

| | Properties | | | |
|---|---|---|---|---|
| | | Width of | maximum full width | |
| Formed | Tensile | Blister through | of peeling in | |
| body | strength | corrosion test | warm salt water | |
| No. | (MPa) | SAE-J2334 (mm) | test (mm) | Remarks |
| XA-1 | 946 | 1 | 3 | Example of the invention |
| XB-1 | 1316 | 1 | 3 | Example of the invention |
| XC-1 | 1507 | 2 | 3 | Example of the invention |
| XC-2 | 1511 | 1 | 3 | Example of the invention |
| XC-3 | 1509 | 2 | 2 | Example of the invention |
| XC-4 | 1516 | 2 | 4 | Example of the invention |
| XC-5 | 1520 | 2 | 3 | Example of the invention |
| XC-6 | 1519 | 11 | 6 | Comparative example |
| XC-7 | 1462 | 16 | 7 | Comparative example |
| XC-8 | 1509 | 10 | 6 | Comparative example |
| XC-9 | 1534 | 17 | 8 | Comparative example |
| XC-10 | 1516 | 3 | 3 | Example of the invention |
| XC-11 | 1509 | 3 | 3 | Example of the invention |
| XC-12 | 1498 | 2 | 3 | Example of the invention |
| XC-13 | 1542 | 3 | 4 | Example of the invention |
| XD-1 | 1836 | 3 | 4 | Example of the invention |
| XD-2 | 1842 | 2 | 3 | Example of the invention |
| XD-3 | 1841 | 1 | 3 | Example of the invention |
| XD-4 | 1840 | 2 | 4 | Example of the invention |
| XD-5 | 1851 | 2 | 2 | Example of the invention |
| XD-6 | 1837 | 11 | 6 | Comparative example |
| XD-7 | 1796 | 14 | 9 | Comparative example |
| XD-8 | 1806 | 12 | 8 | Comparative example |
| XD-9 | 1859 | 19 | 9 | Comparative example |
| XD-10 | 1846 | 2 | 3 | Example of the invention |
| XD-11 | 1869 | 3 | 2 | Example of the invention |
| XE-1 | 2124 | 2 | 3 | Example of the invention |
| XE-2 | 2133 | 2 | 4 | Example of the invention |
| XE-3 | 2067 | 13 | 7 | Comparative example |
| XE-4 | 2100 | 11 | 6 | Comparative example |
| XE-5 | 2159 | 15 | 7 | Comparative example |

TABLE 3-4
Hot-stamped formed body

| | Properties | | | |
|---|---|---|---|---|
| | | Width of | maximum full width | |
| Formed | Tensile | Blister through | of peeling in | |
| body | strength | corrosion test | warm salt water | |
| No. | (MPa) | SAE-J2334 (mm) | test (mm) | Remarks |
| XF-1 | 2468 | 1 | 4 | Example of the invention |
| XG-1 | 1496 | 2 | 3 | Example of the invention |
| XH-1 | 1506 | 1 | 4 | Example of the invention |
| XI-1 | 1537 | 1 | 3 | Example of the invention |
| XJ-1 | 1462 | 2 | 3 | Example of the invention |
| XK-1 | 1498 | 2 | 4 | Example of the invention |
| XL-1 | 1604 | 2 | 4 | Example of the invention |
| XM-1 | 1557 | 1 | 3 | Example of the invention |
| XN-1 | 1549 | 1 | 3 | Example of the invention |
| XO-1 | 1574 | 2 | 4 | Example of the invention |
| XP-1 | 1548 | 3 | 3 | Example of the invention |
| XQ-1 | 1552 | 1 | 4 | Example of the invention |
| XR-1 | 1589 | 1 | 3 | Example of the invention |
| XS-1 | 1483 | 1 | 3 | Example of the invention |
| XT-1 | 1509 | 3 | 3 | Example of the invention |
| Xa-1 | 603 | 19 | 10 | Comparative example |
| Xb-1 | 756 | 18 | 9 | Comparative example |
| Xc-1 | 495 | 2 | 3 | Comparative example |
| Xd-1 | —*1 | 1 | 2 | Comparative example |
| Xe-1 | —*1 | 2 | 1 | Comparative example |
| Xf-1 | 473 | 2 | 1 | Comparative example |
| Xg-1 | —*2 | —*2 | —*2 | Comparative example |
| Xh-1 | —*2 | —*2 | —*2 | Comparative example |
| Xi-1 | —*2 | —*2 | —*2 | Comparative example |
| Xj-1 | 782 | 13 | 7 | Comparative example |
| Xk-1 | 1482 | 12 | 6 | Comparative example |
| Xl-1 | 745 | 15 | 9 | Comparative example |
| Xm-1 | 463 | 2 | 4 | Comparative example |

—*1 indicates that the hot-stamped formed body is embrittle and fractured without reaching the maximum load in the tensile test.
—*2 means that cold rolling could not be performed and the sheet could not pass through the subsequent process.

As can be seen from Tables 1 to 3-4, in Examples of the Invention A-1 to C-5, C-10 to D-5, D-10 to E-2, and F-1 to T-1, the chemical composition, the coating amount of the galvanized layer, the B content of the galvanized layer were within the range of the present invention. In hot-stamped formed bodies XA-1 to XC-5, XC-10 to XD-5, XD-to XE-2, and XF-1 to XT-1, which were obtained by hot-stamping the above steel sheets for hot-stamping, the chemical composition, the microstructure, the coating amount of Γ layer, and Bc/Bq are within the range of the present invention. These hot-stamped formed bodies exhibited high strength and excellent rust resistance.

On the other hand, in formed body obtained by hot stamping the comparative steel sheets in which at least one of the chemical composition, the microstructure, the coating amount, and the B content of a galvanized layer were out of the range of the present invention (XC-6 to C-9, XD-6 to XD-9, XE-3 to XE-5, Xa-1 to Xf-1, and Xj-1 to Xm-1), one or more of the tensile strength and the rust resistance was poor.

In addition, in g-1 to i-1, the hot-rolled steel sheets could not be obtained.

### INDUSTRIAL APPLICABILITY

According to the above aspects of the present invention, it is possible to provide a hot-stamped formed body which can be manufactured under a wide range of heating conditions and has excellent rust resistance (corrosion resistance and adhesion of coating film), a steel sheet for hot-stamping suitable as a material for the hot-stamped formed body, and a method for manufacturing a steel sheet for hot-stamping.

1. A steel sheet for hot-stamping comprising:
a base steel sheet; and
a galvanized layer formed on a surface of the base steel sheet,
wherein the base steel sheet has, in mass %, a chemical composition comprising
C: 0.030% to 0.600%,
Si: 0.01% to 1.50%,
Mn: 0.10% to 2.50%,
Al: 0.001% to 0.100%,
Ti: 0.010% to 0.100%,
B: 0.0005% to 0.0100%,
P: 0.100% or less,
S: 0.0100% or less,
N: 0.0150% or less,
O: 0.0100% or less,
Nb: 0% to 0.050%,
V: 0% to 0.500%,
W: 0% to 0.500%,
Cr: 0% to 1.00%,
Mo: 0% to 0.50%,
Co: 0% to 1.000%,
Ni: 0% to 1.00%,
Cu: 0% to 1.00%,
REM: 0% to 0.0100%,
Zr: 0% to 0.0500%,
Ca: 0% to 0.0100%,
Mg: 0% to 0.0100%,
As: 0% to 0.100%,
Sn: 0% to 0.50%,
Sb: 0% to 0.50%, and
a remainder: Fe and impurities,
wherein a microstructure at a position at ¼ depth which is in a range of ⅛ to ⅜ of a sheet thickness in a sheet thickness direction from the surface of the base steel sheet contains, in volume fraction,
ferrite: 20% to 95% and
pearlite: 5% to 80%,
the remaining structure comprising bainite,
wherein the galvanized layer has a coating amount of 35 g/m² or more, and
wherein, a chemical composition of the galvanized layer includes 0.0005 mass % or more of B.

2. The steel sheet for hot-stamping according to claim 1,
wherein the chemical composition of the galvanized layer includes, in terms of mass, Fe: less than 9.0%.

3. The steel sheet for hot-stamping according to claim 1,
wherein a chemical composition of the galvanized layer includes, in terms of mass, Fe: 9.0% or more.

4. The steel sheet for hot-stamping according to claim 1,
wherein the chemical composition of the base steel sheet comprises, in mass %, one or more of
Nb: 0.005% to 0.050%,
V: 0.005% to 0.500%,
W: 0.005% to 0.500%,
Cr: 0.01% to 1.00%,
Mo: 0.01% to 0.50%,
Co: 0.01% to 1.000%,
Ni: 0.01% to 1.00%,
Cu: 0.01% to 1.00%,
REM: 0.0003% to 0.0100%,
Zr: 0.0003% to 0.0500%,
Ca: 0.0003% to 0.0100%,
Mg: 0.0003% to 0.0100%,
As: 0.001% to 0.100%,
Sn: 0.01% to 0.50%, and
Sb: 0.01% to 0.50%.

5. A method for manufacturing a steel sheet for hot-stamping, comprising:
casting a steel ingot or a slab having chemical components including, in mass %, C: 0.030% to 0.600%, Si: 0.01% to 1.50%, Mn: 0.10% to 2.50%, Al: 0.001% to 0.100%, Ti: 0.010% to 0.100%, B: 0.0005% to 0.0100%, P: 0.100% or less, S: 0.0100% or less, N: 0.0150% or less, O: 0.0100% or less, Nb: 0% to 0.050%, V: 0% to 0.500%, W: 0% to 0.500%, Cr: 0% to 1.00%, Mo: 0% to 0.50%, Co: 0% to 1.000%, Ni: 0% to 1.00%, Cu: 0% to 1.00%, REM: 0% to 0.0100%, Zr: 0% to 0.0500%, Ca: 0% to 0.0100%, Mg: 0% to 0.0100%, As: 0% to 0.100%, Sn: 0% to 0.50%, Sb: 0% to 0.50%, and a remainder: Fe and impurities;
heating the steel ingot or the slab to 1,100° C. or higher and hot rolling the heated steel ingot or slab so that a finish rolling temperature is 800° C. or higher to obtain a hot-rolled steel sheet;
coiling the hot-rolled steel sheet after the hot rolling in a temperature range of 600° C. or lower;
pickling the hot-rolled steel sheet after the coiling, and then performing cold rolling at a cumulative rolling reduction of 30% to 80% to obtain a cold-rolled steel sheet;
performing annealing by holding the cold-rolled steel sheet in an annealing furnace, in which an oxygen potential in an atmosphere is −1.20 to −0.50 and a temperature of the atmosphere is 650° C. or more and less than 800° C., for 30 seconds or longer and cooling the steel sheet so that the steel sheet surface temperature is 500° C. to 400° C.;
performing plating by immersing the cold-rolled steel sheet after the annealing in a plating bath to form a plating layer with a coating amount of 35 g/m² or more; and
cooling the cold-rolled steel sheet after the plating to 50° C. or lower.

6. The method for manufacturing a steel sheet for hot-stamping according to claim 5,
the method further comprising;
performing alloying by holding the cold rolled steel sheet in a furnace in which a temperature of the atmosphere is 460 to 600° C., for 5 seconds or longer, between the plating and the cooling.

7. A hot-stamped formed body comprising:
a base steel sheet; and
a plating layer containing Zn and Fe and formed on a surface of the base steel sheet,
wherein the base steel sheet has, in mass %, a chemical composition comprising
C: 0.030% to 0.600%,
Si: 0.01% to 1.50%,
Mn: 0.10% to 2.50%,
Al: 0.001% to 0.100%,
Ti: 0.010% to 0.100%,
B: 0.0005% to 0.0100%,
P: 0.100% or less,
S: 0.0100% or less,
N: 0.0150% or less,
O: 0.0100% or less,
Nb: 0% to 0.050%,
V: 0% to 0.500%,
W: 0% to 0.500%,
Cr: 0% to 1.00%,
Mo: 0% to 0.50%,
Co: 0% to 1.000%,
Ni: 0% to 1.00%,
Cu: 0% to 1.00%,
REM: 0% to 0.0100%,
Zr: 0% to 0.0500%,
Ca: 0% to 0.0100%,
Mg: 0% to 0.0100%,
As: 0% to 0.100%,
Sn: 0% to 0.50%,
Sb: 0% to 0.50%, and
a remainder: Fe and impurities,
wherein a microstructure at a position at ¼ depth which is in a range of ⅛ to ⅜ of a sheet thickness in a sheet thickness direction from the surface of the base steel sheet contains, in volume fraction,
martensite: 5% to 100% and
ferrite: 0% to 95%,
the remaining structure comprising one or two of bainite and pearlite,
wherein a Γ layer having a Fe content of 9 to 30 mass % in the plating layer has a coating amount of 30 g/m² or more, and
wherein, when a maximum value of a B content in mass % in the plating layer is Bc and a B content at a position at ¼ depth of the base steel sheet in mass % is Bq, Bc is 1.2 times or more Bq.

8. The hot-stamped formed body according to claim 7,
wherein the chemical composition of the base steel sheet contains, in mass %, one or more of
Nb: 0.005% to 0.050%,
V: 0.005% to 0.500%,
W: 0.005% to 0.500%,
Cr: 0.01% to 1.00%,
Mo: 0.01% to 0.50%,
Co: 0.01% to 1.000%,
Ni: 0.01% to 1.00%,
Cu: 0.01% to 1.00%,
REM: 0.0003% to 0.0100%,
Zr: 0.0003% to 0.0500%,
Ca: 0.0003% to 0.0100%,
Mg: 0.0003% to 0.0100%,
As: 0.001% to 0.100%,
Sn: 0.01% to 0.50%, and
Sb: 0.01% to 0.50%.
